(19) United States
(12) Patent Application Publication
(10) Pub. No.: US 2015/0206265 A1
(43) Pub. Date: Jul. 23, 2015

(54) METHODS, SYSTEMS, AND DEVICES FOR GATHERING AND PROVIDING PUBLIC OPINION INFORMATION

(71) Applicant: Ron Tupa, Boulder, CO (US)

(72) Inventor: Ron Tupa, Boulder, CO (US)

(21) Appl. No.: 14/600,061

(22) Filed: Jan. 20, 2015

Related U.S. Application Data
(60) Provisional application No. 61/928,501, filed on Jan. 17, 2014.

(51) Int. Cl. G06Q 50/26; G07C 13/00; G06Q 30/02

(52) U.S. Cl. CPC G06Q 50/26; G06Q 30/0201; G07C 13/00

(57) ABSTRACT

Methods, systems, and devices are provided for gathering and/or providing public opinion by querying users on specific legislative questions or issues (like various commissioned public opinion polls), which may allow officeholders at the national, state, and local level to learn the preferences and/or opinions of their constituents before they cast a vote or take a position on the issue in question. In some embodiments, subscriber or user data may be received, compiled, aggregated, and/or distributed back out to the user and/or to the public in general in a timely fashion. Some embodiments may utilize running tallying and/or alignment features between user preferences and public officials, including information regarding how elected officials may vote or otherwise take action and over time as it may relate to user preferences.

### CROSS-REFERENCES TO RELATED APPLICATIONS

This application is a non-provisional patent application claiming priority benefit of U.S. provisional patent application Ser. No. 61/928,501, filed on Jan. 17, 2014 and entitled “METHODS, SYSTEMS, AND DEVICES FOR GATHERING AND PROVIDNG PUBLIC OPINION INFORMATION,” the entire disclosure of which is herein incorporated by reference for all purposes.

### BACKGROUND

Different tools and techniques may generally be utilized to gather public opinion on different issues of public interest. These generally include different survey techniques. Information also may be gathered and/or provided about how different public officials may vote on different matters of public interest, such as legislative matters. However, public officials may often not know public opinion on different specific matters. Furthermore, members of the public may often not know how specific legislators or other public officials may actually vote on different matters that they may be specifically interested in. There may thus be a need for different tools and techniques to better gather and/or provide information to voters and/or public officials.

### BRIEF SUMMARY

Methods, systems, and devices are provided for gathering and/or providing public opinion by querying users on specific legislative questions or issues (like various commissioned public opinion polls), which may allow officeholders at the national, state, and local level to learn the preferences and/or opinions of their constituents before they cast a vote or take a position on the issue in question. In some embodiments, subscriber or user data may be received, compiled, aggregated, and distributed back out to the user and/or to the public in general in a timely fashion.

In some cases, a running tally may be kept of how closely aligned the public and/or elected official's positions and/or votes are with each specific subscriber over time. In some cases, the information may be disaggregated in myriad ways to align with subscribers by precinct, neighborhood, city/county, house district, senate district, congressional district, by age, sex, etc.

For example, multiple users may be registered, at one or more computers. The registration may include authenticating at least an age of each user, a geographic location of each user, a voter registration status of each user, a party affiliation of each user, or a voter activity level of each user. One or more areas of interest for each of the users may be determined. At least one measure being considered by a political body related to at least one of the areas of interest for at least a subset of the multiple users may be identified. At least one question to the subset of multiple users may be transmitted from the one or more computers. The at least one question may relate to at least one of the measures being considered by the political body related to at least one of the areas of interest of the subset of the multiple users. One or more responses may be received from the subset of multiple users regarding the at least one question related to the at least one measure being considered by the political body related to the at least one area of interest of the subset of multiple users. Results may be compiled based on the one or more responses from the subset of multiple users.

Some embodiments include a method of gathering public opinion information that may include registering multiple users at one or more computers. The registration may include authenticating at least an age of each user, a geographic location of each user, a voter registration status of each user, a party affiliation, or a voter activity level of each user. The registration process may include receiving a digital registration signal from a user device from each user. Additional digital signals from the user devices may also be received. These digital signals may be utilized for a variety of purposes, including utilized with regarding to the following aspects of the method. The method may also include: determining one or more areas of interest for each of the users; and/or identifying at least one measure being considered by a political body related to at least one of the areas of interest for at least a subset of the multiple users. The method may include transmitting, from the one or more computers, at least one question to the subset of multiple users, wherein the at least one question relates to at least one of the measures being considered by the political body related to at least one of the areas of interest of the subset of the multiple users. The method may include receiving one or more responses from the subset of multiple users regarding the at least one question related to the at least one measure being considered by the political body related to the at least one area of interest of the subset of multiple users. The method may include compiling results based on the one or more responses from the subset of multiple users. A database may be updated with the results based on the one or more responses from the users. Some embodiments of the method may include transmitting the compiled results to at least one member of the political body or one or more users from the subset of multiple users.

Some embodiments of the method may include determining one or more specific votes by one or more members of the political body with respect to the at least one measure. The method may include comparing the one or more determined specific votes by the one or more members of the political body with the one or more received responses from the subset of multiple users. Some embodiments may include transmitting information related to the comparison to the individual users from the subset of multiple users.

Some embodiments of the method may include: disaggregating the compiled results based upon at least gender, age, party affiliation, or geographical information of the subset of multiple users; and/or providing publicly the disaggregated results.

Some embodiments of the method may include: aggregating the compiled results based upon at least gender, age, party affiliation, or geographical information of the subset of multiple users; and/or providing publicly the aggregated results.

Some embodiments of the method may include determining information regarding individual users from the subset of users at least at a precinct level, a city level, a county level, or a school district level. Some embodiments of the method may include: generating a map based on the compiled results; and/or presenting the generated map of results. In some embodiments of the method, the map reflects an alignment of the subset of users with one or more members of the political body.

Some embodiments include a system for gathering public opinion information that may include one or more processors that may be configured to register multiple users at one or more computers. The registration may include authenticating at least an age of each user, a geographic location of each user, a voter registration status of each user, a party affiliation, or a voter activity level of each user. The one or more processors may be configured: determine one or more areas of interest for each of the users; and/or identify at least one measure being considered by a political body related to at least one of the areas of interest for at least a subset of the multiple users. The one or more processors may be configured transmit, from the one or more computers, at least one question to the subset of multiple users, wherein the at least one question relates to at least one of the measures being considered by the political body related to at least one of the areas of interest of the subset of the multiple users. The one or more processors may be configured: receive one or more responses from the subset of multiple users regarding the at least one question related to the at least one measure being considered by the political body related to the at least one area of interest of the subset of multiple users. The one or more processors may be configured compile results based on the one or more responses from the subset of multiple users.

In some embodiments, the one or more processors are further configured to transmit the compiled results to at least one member of the political body or one or more users from the subset of multiple users. In some embodiments, the one or more processors are further configured to determine one or more specific votes by one or more members of the political body with respect to the at least one measure. In some embodiments, the one or more processors are further configured to compare the one or more determined specific votes by the one or more members of the political body with the one or more received responses from the subset of multiple users. In some embodiments, the one or more processors are further configured to transmit information related to the comparison to the individual users from the subset of multiple users.

In some embodiments, the one or more processors are further configured to: disaggregate the compiled results based upon at least gender, age, party affiliation, or geographical information of the subset of multiple users; and/or provide publicly the disaggregated results.

In some embodiments, the one or more processors are further configured to: aggregate the compiled results based upon at least gender, age, party affiliation, or geographical information of the subset of multiple users; and/or provide publicly the aggregated results.

In some embodiments, the one or more processors are further configured to determine information regarding individual users from the subset of users at least at a precinct level, a city level, a county level, or a school district level.

In some embodiments, the one or more processors are further configured to: generate a map based on the compiled results; and/or present the generated map of results. The map may reflect an alignment of the subset of users with one or more members of the political body.

Some embodiments include a method of gathering public opinion information. The method may include receiving a registration digital signal from a user device to register a user at a computer system. The method may include extracting digital information from the received registration digital signal to authenticate at least an age of the user, a geographic location of the user, a voter registration status of the user, a party affiliation, or a voter activity level of the user. The method may include generating an input user interface for the user device of the user to determine one or more measures of interest to the user being considered by a political body. The method may include receiving one or more response digital signals from the user device regarding one or more one responses related to the one or more measures of interest to the user being considered by the political body. The method may include determining one or more votes of one of more members from the political body with regard to the one or more measures using the computer system. The method may include transforming the one or more responses from the user device and the one or more votes of the one or more members from the political body to reflect the relationship between the one or more responses of the user and the one or more votes of the one or more members from the political body. The method may include generating a digital output graphic for the user device to reflect the relationship between the one or more responses of the user and the one or more votes of the one or more members from the political body with respect to the one or more measures.

Some embodiments of the method may further include transmitting the one or more responses received from the user device to one or more devices of the one or more members from the political body. Some embodiments may include: determining multiple stages with respect to the one or more measures; and/or generating a digital stages graphic for the user device to reflect the multiple stages along with the one or more responses of the user or the one or more votes of the one or more members from the political body.

Some embodiments of the method may further include determining a change with respect to at least one of the one or more measures. One or more queries may be transmitted to the user device of the user that reflects the change of the one or more measures. One or more updated responses may be received from the user device with respect to the change of the one or more measures. An update response graphic may be generated for the user device to reflect the updated response. Some embodiments may further include: determining one or more updated votes of the one of more members from the political body with regard the change with respect to the one or more measures; and/or generating a digital update stages graphic to reflect the relationship between the updated votes of the one or more members from the political body and the updated responses from the user with respect to the multiple stages. Some embodiments may further include generating a digital aggregate results graphic reflecting the aggregate results of the user compared to the one or more members from the political body with respect to the one or more measures.

Some embodiments of the method include protecting the user votes from being identified by an administrator of the computer system. Some embodiments of the method include: aggregating results based upon at least gender, age, party affiliation, or geographical information of multiple users; and/or transmitting the aggregated results in digital format for public display. Some embodiments of the method include generating a digital graphic map based on the aggregated results for the user device. The digital graphic map may reflect an alignment of the subset of users with one or more members from the political body.

Some embodiments include a system for gathering public opinion information that may include one or more processors configured to receive a registration digital signal from a user device to register a user at a computer system. The one or more processors may be configured to extract digital information from the received registration digital signal to authenticate at least an age of the user, a geographic location of the user, a voter registration status of the user, a party affiliation, or a voter activity level of the user. The one or more processors may be configured to generate an input user interface for the user device of the user to determine one or more measures of interest to the user being considered by a political body. The one or more processors may be configured to receive one or more response digital signals from the user device regarding one or more one responses related to the one or more measures being considered by the political body of interest to the user. The one or more processors may be configured to determine one or more votes of one of more members from the political body with regard to the one or more measures using the computer system. The one or more processors may be configured to transform the one or more responses from the user device and the one or more votes of the one or more members from the political body to reflect the relationship between the one or more responses of the user and the one or more votes of the one or more members from the political body. The one or more processors may be configured to generate a digital output graphic for the user device to reflect the relationships between the one or more responses of the user and the one or more votes of the one or more members from the political body with respect to the one or more measures.

In some embodiments of the system, the one or more processors are further configured to transmit the one or more responses received from the user device to one or more devices of the one or more members from the political body. The one or more processors may be configured to determine multiple stages with respect to the one or more measures. The one or more processors may be configured to generate a digital stages graphic for the user device to reflect the multiple stages along with the one or more responses of the user or the one or more votes of the one or more members from the political body.

In some embodiments of the system, the one or more processors are further configured to determine a change with respect to at least one of the one or more measures. The one or more processors may be configured to transmit one or more queries to the user device of the user that reflects the change of the one or more measures. The one or more processors may be configured to receive one or more updated responses from the user device with respected to the change of the one of more measures. The one or more processors may be configured to generate an update response graphic for the user device to reflect the updated response.

In some embodiments of the system, the one or more processors are further configured to determine one or more updated votes of the one of more members from the political body with regard the change with respect to the one or more measures. The one or more processors may be configured to generate a digital update stages graphic to reflect the relationship between the updated votes of the one or more members and the updated responses from the user with respect to the multiple stages. The one or more processors may be further configured to generate a digital aggregate results graphic reflecting the aggregate results of the user compared to the one or more members from the political body with respect to the one or more measures.

In some embodiments of the system, the one or more processors are further configured protect the user votes from being identified by an administrator of the computer system. In some embodiments of the system, the one or more processors are further configured to: aggregate results based upon at least gender, age, party affiliation, or geographical information of a plurality of users; and/or transmit the aggregated results in digital format for public display. In some embodiments of the system, the one or more processors are further configured to generate a digital graphic map based on the aggregated results for the user device.

Some embodiments include a system for gathering public opinion information that may include: means for receiving a registration digital signal from a user device to register a user at a computer system; means for extracting digital information from the received registration digital signal to authenticate at least an age of the user, a geographic location of the user, a voter registration status of the user, a party affiliation, or a voter activity level of the user; means for generating an input user interface for the user device of the user to determine one or more measures of interest to the user being considered by a political body; means for receiving one or more response digital signals from the user device regarding one or more one responses related to the one or more measures being considered by the political body of interest to the user; means for determining one or more votes of one of more members from the political body with regard to the one or more measures using the computer system; means for transforming the one or more responses from the user device and the one or more votes of the one or more members from the political body to reflect the relationship between the one or more responses of the user and the one or more votes of the one or more members from the political body; and/or means for generating a digital output graphic for the user device to reflect the relationships between the one or more responses of the user and the one or more votes of the one or more members from the political body with respect to the one or more measures.

Some embodiments include a method of gathering public opinion information that may include transmitting a registration digital signal from a user device to register a user at a computer system. The method may include generating an input user interface for the user device of the user to determine one or more measures of interest to the user being considered by a political body. The method may include transmitting one or more response digital signals from the user device regarding one or more responses related to the one or more measures being considered by the political body of interest to the user. The method may include transforming the one or more responses from the user device and one or more votes of the one or more members from the political body to reflect the relationship between the one or more responses of the user and the one or more votes of the one or more members from the political body. The method may include generating a digital output graphic for the user device to reflect the relationships between the one or more responses of the user and the one or more votes of the one or more members from the political body with respect to the one or more measures.

Some embodiments of the method may include transmitting the one or more responses from the user device to one or more devices of the one or more members from the political body. Some embodiments of the method may include: determining multiple stages with respect to the one or more measures; and/or generating a digital stages graphic for the user device to reflect the multiple stages along with at least the responses of the user or the votes of the members.

Some embodiments of the method may include: receiving one or more queries to the user device of the user that reflects the change of the measure; transmitting one or more updated responses from the user device with respected to the change of the measure; and/or generating an update response graphic for the user device to reflect the updated response. Some embodiments may include generating a digital update stages graphic to reflect the relationship between updated votes of the one or more members and the updated responses from the user with respect to the multiple stages. Some embodiments of the method may include generating a digital aggregate results graphic reflecting the aggregate results of the user compared to the one or more members from the user.

Some embodiments include a user device for gathering public opinion information. The user device may include one or more processors configured to: transmit a registration digital signal from the user device to register a user at a computer system; generate an input user interface for the user device of the user to determine one or more measures of interest to the user being considered by a political body; transmit one or more response digital signals from the user device regarding one or more one responses related to the one or more measures being considered by the political body of interest to the user; transform the one or more responses from the user device and one or more votes of the one or more members from the political body to reflect the relationship between the one or more responses of the user and the one or more votes of the one or more members from the political body; and/or generate a digital output graphic for the user device to reflect the relationships between the one or more responses of the user and the one or more votes of the one or more members from the political body with respect to the one or more measures.

In some embodiments of the user device, the one or more processors are further configured to transmit the one or more responses from the user device to one or more devices of the one or more members from the political body. In some embodiments of the device, the one or more processors are further configured to: determining multiple stages with respect to the one or more measures; and/or generate a digital stages graphic for the user device to reflect the plurality of stages along with at least the responses of the user or the votes of the members.

In some embodiments of the user device, the one or more processors are further configured to: determine a change with respect to at least one of the one or more measures; transmit one or more queries to the user device of the user that reflects the change of the measure; receive one or more updated responses from the user device with respected to the change of the measure; and/or generate an update response graphic for the user device to reflect the updated response. In some embodiments, one or more processors are further configured to: determine one or more updated votes of one of more members from the political body with regard the change with respect to the one or more measures; and/or generate a digital update stages graphic to reflect the relationship between the updated votes of the one or more members and the updated responses from the user with respect to the multiple stages. The one or more processors may be further configured to generate a digital aggregate results graphic reflecting the aggregate results of the user compared to the one or more members from the user.

In some embodiments of the user device, one or more processors are further configured to protect the user votes from being identified by an administrator of the computer system. In some embodiments of the user device, the one or more processors are further configured to: aggregate compiled results based upon at least gender, age, party affiliation, or geographical information of a plurality of users; and/or transmit the aggregated results in digital format for public display. The one or more processors may be further configured to generate a digital graphic map based on the compiled results for the user device.

Some embodiments include a system of gathering public opinion information that may include a means for transmitting a registration digital signal from a user device to register a user at a computer system. The system may include a means for generating an input user interface for the user device of the user to determine one or more measures of interest to the user being considered by a political body. The system may include a means for transmitting one or more response digital signals from the user device regarding one or more responses related to the one or more measures being considered by the political body of interest to the user. The system may include a means for transforming the one or more responses from the user device and one or more votes of the one or more members from the political body to reflect the relationship between the one or more responses of the user and the one or more votes of the one or more members from the political body. The system may include a means for generating a digital output graphic for the user device to reflect the relationships between the one or more responses of the user and the one or more votes of the one or more members from the political body with respect to the one or more measures.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an environment for gathering and/or providing public opinion information in accordance with various embodiments.

FIG. 2A shows a block diagram of a system for gathering and/or providing public opinion information in accordance with various embodiments.

FIG. 2B shows a block diagram of a system for gathering and/or providing public opinion information in accordance with various embodiments.

FIG. 2C shows a block diagram of a system for gathering and/or providing public opinion information in accordance with various embodiments.

FIG. 2D shows a block diagram of a system for gathering and/or providing public opinion information in accordance with various embodiments.

FIG. 2E shows a block diagram of a system for gathering and/or providing public opinion information in accordance with various embodiments.

FIG. 2F shows a block diagram of a system for gathering and/or providing public opinion information in accordance with various embodiments.

FIGS. 3A, 3B, 3C, and 3D show different database tables that may be utilized for gathering and/or providing public opinion information in accordance with various embodiments.

FIGS. 3E, 3F, 3G, 3H, 3I, 3J, and 3K show staging and other charts that may be utilized for gathering and/or providing public opinion information in accordance with various embodiments.

FIGS. 3L, 3M, 3N, 3O, and 3P show digital interfaces that may be utilized for gathering and/or providing public opinion information in accordance with various embodiments.

FIG. 4A is a flow diagram for gathering and/or providing public opinion information in accordance with various embodiments.

FIG. 4B is a flow diagram for gathering and/or providing public opinion information in accordance with various embodiments.

FIG. 4C is a flow diagram for gathering and/or providing public opinion information in accordance with various embodiments.

FIG. 4D is a flow diagram for gathering and/or providing public opinion information in accordance with various embodiments.

FIG. 4E is a flow diagram for gathering and/or providing public opinion information in accordance with various embodiments.

FIG. 4F is a flow diagram for gathering and/or providing public opinion information in accordance with various embodiments.

FIG. 5A shows a block diagram of a special purpose computer configured for gathering and/or providing public opinion information in accordance with various embodiments.

FIG. 5B shows a block diagram of a special purpose computer configured for gathering and/or providing public opinion information in accordance with various embodiments.

FIG. 6 shows a block diagram of a user device configured for gathering and/or providing public opinion information in accordance with various embodiments.

### DETAILED DESCRIPTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments, it being understood that various changes may be made in the function and arrangement of elements without departing from the spirit and scope of the invention as set forth in the appended claims. Several embodiments are described herein, and while various features are ascribed to different embodiments, it should be appreciated that the features described with respect to one embodiment may be incorporated within other embodiments as well. By the same token, however, no single feature or features of any described embodiment should be considered essential to every embodiment of the invention, as other embodiments of the invention may omit such features.

Specific details are given in the following description to provide a thorough understanding of the embodiments. However, it will be understood by one of ordinary skill in the art that the embodiments may be practiced without these specific details. For example, systems, networks, processes, and other elements in embodiments may be shown as components in block diagram form in order not to obscure the embodiments in unnecessary detail. In other instances, well-known processes, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process may be terminated when its operations are completed, but could also comprise additional operations not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, embodiments may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Some embodiments provide for gathering and/or providing public opinion by querying users on specific legislative questions or issues (like various commissioned public opinion polls), which may allow officeholders at the federal, state, and local level to learn the preferences and/or opinions of their constituents before they cast a vote or take a position on the issue in question. In some embodiments, subscriber data may be received, compiled, aggregated, and distributed back out to the user and/or to the public in general in a timely fashion. Some embodiments include an interactive and downloadable Internet platform hosted in the cloud and physically present on a local ISP server that may provide a service.

In some cases, a running tally may be kept of how closely aligned the public and/or elected official's positions and/or votes are with each specific subscriber over time. In some cases, the information may be disaggregated in myriad ways to align with subscribers by precinct, neighborhood, city/county, house district, senate district, congressional district, by age, sex, etc.

Merely by way of example, after 16 months in office and facing a primary challenge, elected official A might be voting in alignment with subscriber #103 only 45% of the time based on their important issues, but with subscriber #1209 a much healthier 75% of the time. People may be able to use this data when determining whether to support elected official A. Some embodiments may also be able to aggregate this information for public consumption, by announcing on issues of “education” or “the environment,” an elected official A may reflect the subscribers viewpoints 65% of the time for certain precincts within the city of boulder, 50% of the time for the city of boulder in general, but only 40% of the time for countywide resident subscribers, etc.

Some embodiments may utilize user authentication. For example, each voting aged user (e.g., 18+ only) may be uniquely identifiable, based on geographic location for example, and matched to public voter registration information if available. Some embodiments may provide for posting commentary about their position on issues or their support or opposition to how elected officials might be voting on their behalf. In some embodiments, interaction may be considered an option.

Some embodiments may allow for a multi-tiered service model based on cost. For example, a Level 1 may provide a free, basic version of the service, offering the fewest opportunities for opinion gathering (for example, only 10 specific issues) and the least amount of information. Level 2 may provide cost a minimum amount per month, for example $1, and offer between 11-25 questions or issues and more interaction and graphics, a lengthier explanation of issues, etc. Level 3 may provide the 26-50 question range with the most bells and whistles, the prettiest graphics, the most detailed analysis or explanation of issues, more opportunities for interaction, etc. for $10 a month.

Some embodiments may include not selling or otherwise divulging any information about its users, nor make user information available to anyone. In some cases, revenue may not be made from selling advertisements or by allowing other organizations to post on our site, etc. In some cases, revenue source may include subscriber fees per user that may depend upon level of service. In some cases, brand loyalty, user comfort and/or satisfaction, and/or increased interactive service between different levels for subscribers may be relevant.

Some embodiments may break down users geographically by precinct to establish state house and senate districts, and/or congressional districts. Some embodiments may be able to distinguish users by more local subdivisions including counties, city council districts/wards, school board member district boundaries, special district boundaries, etc. Some embodiments may utilize a GPS capability of cell phones as part of the overall authentication process. Some embodiments may provide authentication by proxy via the state's voter registration lists and/or another process of authentication. Some embodiments may be able to handle non-registered voters.

Some embodiments may include different database structures that may include different fields regarding different authenticated users including, but not limited to, name, date of birth, address, sex, house district, senate district, congressional district, precinct, subjects, and/or areas of interests. Some embodiments may include databases that may include bill numbers, bill titles, bill subjects, bill summaries, bill details, and/or bill texts. Users and/or subscribers may weigh in and indicate preferences for or against (or don't know/don't care) for their chosen bills.

Some embodiments may involve tracking specific legislation at a state capitol and/or a federal capitol. Some embodiments may track actions being voted upon a town, city, county, and/or school district level. Some embodiments may summarize information regarding specific legislation or matters being considered by a political body and upload the information in a timely fashion in order to be used to gauge the opinion of users. That information may be broken into subjects and/or topics from which the public can choose to weigh in, based on previously indicated user and/or subscriber preferences (e.g., guns, abortion rights, the environment, taxes, etc.) established during the authentication phase.

In some embodiments, based on a level of the user, the poll questions may be pushed out to user and/or subscribers in order to elicit a response and gather feedback within a designated timeframe. These time frames may vary, for example, 1 hour, 3 hours, 6 hours, 12 hours, 24 hours, 36 hours, etc. These times frames may help to ensure public posting in a timely fashion. In some cases, before final vote is taken on the legislation, ordinance, etc. by the elected official, there may be times when this is not possible, but the public posting may occur as soon as technically feasible.

In some embodiments, the polled user and/or subscriber information may be disaggregated down to different levels, such as a precinct level or lower level. In some cases, this disaggregated information may provide a useful model and/or tool for where and how citizens are responding to specific questions of public policy compared to how those issues are actually voted on by their own elected officials. Polled information may not be publicly released to correspond to any individual user and/or subscriber. Polled information may be released in aggregated or disaggregated format, which may not be individually identifiable.

Some embodiments may provide a map feature that may aggregate and/or disaggregate user and/or subscriber preferences, which may show alignment or non-alignment with elected officials voting actions. For example, an interactive map of the whole state may have precinct specific information broken down by issue, which may then be aggregated into state house and senate districts, then congressional districts, etc. User and/or subscribers may see how elected officials align with their responses, the number of other user and/or subscribers located in other precincts, the percentages of alignment, and/or the number of issues tabulated, etc. In some embodiments, the map features may include interactive type maps that may utilize color scales (e.g., blue for cold, yellow for warm, red for hot, shades of grey, etc.) Some users and/or subscribers may expect more interactivity and/or details for graphics and functionality, which may be provided in different embodiments. Some maps can be used by the general public—even non user and/or subscribers—and others may only be available to users.

Some embodiments may provide more interactive opportunities for users to contact their legislators and political officials about their opinions on issues, send correspondence to newspapers, post comments in public domains, start their own petitions or ideas for legislation, and/or interact with other users, etc. from our platform. In some embodiments, users may be able to link to websites of elected officials and other public or government sites that connect them to specific bills or information about issues, candidates, organizations, and/or outside sources, etc. Some embodiments may provide for links to other petition sites (e.g., change.org, moveon.org, Care2petition.org, etc.), political parties, news media, etc. Users may be able to contact political officials through electronic communication, such as email, to provide their opinions on whether they support different bills or measures before the political officials. Users may be able to send this information before or after different votes that different officials may make, such as during a legislative session at the different stages that the measure may go through as it passes through a legislature or other political body. In some cases, this information may be provided as aggregated data to the political officials.

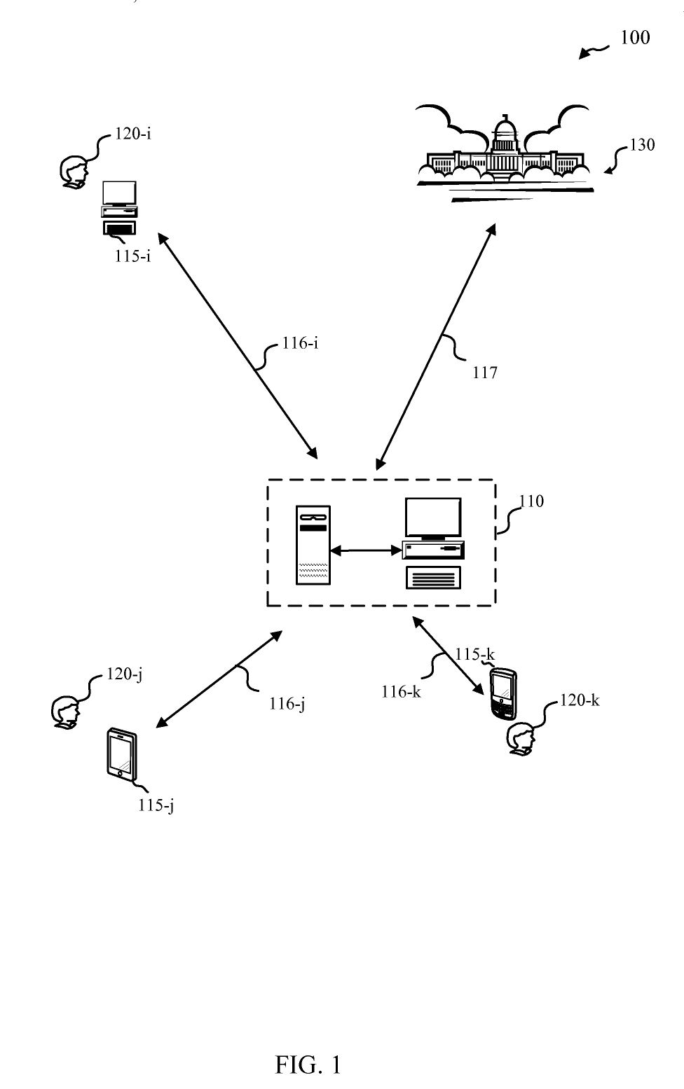

Referring next to FIG. 1, an exemplary environment 100 with which embodiments may be implemented is shown with a computer system 110. The computer system 110 may include a variety of devices such as a computer/processor, a keyboard, a monitor, a printer, a server, and/or a network router. The monitor, processor, and keyboard may be part of a laptop computer, desktop computer, handheld computer, mainframe computer, etc. In some cases, computer system 110 may also utilize different mobiles devices including, but not limited to, cell phones, smart devices, tablets, and/or portable computers.

Environment 100 may also include multiple users and/or subscribers 120-i, 120-j, and/or 120-k. The users and/or subscribers 120 may utilize a variety of devices 115, such as a desktop computer 115-i, a tablet 115-j, and/or cell phone 115-k, or other communication devices, which may include mobile and/or stationary devices, to communicate 116-i, 116-j, 116-k with computer system 100. Computer system 100 may also be in communication 117 with political body 130.

Computer system 100 may be utilized to gather and/or provide public opinion information in accordance with various embodiments. For example, computer system 100 may be utilized to gather public opinion by querying users 120 on specific legislative questions or issues. This may allow public officials 130, such as officeholders at the federal, state, and/or local level to learn the preferences and/or opinions of their constituents, such as users 120, before they cast a vote or take a position on the issue in question. The public opinion information may be received, compiled, aggregated, and/or distributed back from computer system 110 to users 120, political officials 130, and/or to the public in general in a timely fashion.

In some embodiments, computer system 100 may keep a running tally of how closely aligned the public (such as users 120) and/or elected official's positions from political body 130 and/or votes are with each specific users 120 over time. In some cases, the information may be disaggregated by computer system 110 in myriad ways to align with users 120 by precinct, neighborhood, city/county, house district, senate district, congressional district, by age, sex, etc.

In another example, computer system 100 may register multiple users 120. The registration may include authenticating at least an age of each user 120, a geographic location of each user 120, a voter registration status of each user 120, a party affiliation of each user 120, or a voter activity level of each user 120. This may involve receiving digital registration signals from the users 120 via their user devices 115. One or more areas of interest for each of the users 120 may be determined by computer system 110. At least one measure being considered by political body 130 related to at least one of the areas of interest for at least a subset of the multiple users 120 may be identified by computer system 110.

At least one question to the subset of multiple users 120 may be transmitted from the computer system 110. The at least one question may relate to at least one of the measures being considered by the political body 130 related to at least one of the areas of interest of the subset of the multiple users 120. One or more responses may be received from the subset of multiple users 120 regarding the at least one question related to the at least one measure being considered by the political body 130 related to the at least one area of interest of the subset of multiple users 120. Results may be compiled by computer system 110 based on the one or more responses from the subset of multiple users 120.

Some embodiments of system 100 may be configured such that computer system 110 may receive a registration digital signal from one or more of the user devices 115 to register a user 120 at a computer system 110. Computer system 110 may extract digital information from the received registration digital signal to authenticate at least an age of the user, a geographic location of the user, a voter registration status of the user, a party affiliation, or a voter activity level of the user. The computer system 110 and/or one or more of the user devices 115 may be configured to generate an input user interface for the user device 115 of the user to determine one or more measures of interest to the user being considered by a political body. Computer system 110 may be configure to receive one or more response digital signals from one or more of the user devices 115 regarding one or more one responses related to the one or more measures being considered by the political body of interest to the user. The computer system 110 may be configured to determine one or more votes of one of more members from the political body with regard to the one or more measures using the computer system 110. The computer system 110 and/or one or more the user devices 115 may be configured to transform the one or more responses from the user device 115 and the one or more votes of the one or more members from the political body to reflect the relationship between the one or more responses of the user and the one or more votes of the one or more members of the political body. The computer system 110 and/or one or more the user devices 115 may be configured to generate a digital output graphic for the user device 115 to reflect the relationships between the one or more responses of the user and the one or more votes of the one or more members of the political body with respect to the one or more measures. Some embodiments of system 100 may be configured such that the computer system 110 and/or one or more of the user devices 115 may transmit the one or more responses from the user device 115 to one or more devices of the one or more members of the political body.

Some embodiments of system 100 may be configured such that the computer system 110 and/or one or more of the user devices 115 may determine multiple stages with respect to the one or more measures. The computer system 110 and/or one or more of the user devices 115 may generate a digital stages graphic for the user device 115 to reflect the multiple stages along with at least the responses of the user or the votes of the members.

Some embodiments of system 100 may be configured such that the computer system 110 and/or one or more of the user devices 115 may determine a change with respect to at least one of the one or more measures. The computer system 110 and/or one or more of the user devices 115 may transmit one or more queries to the user device 115 of the user that reflects the change of the measure. The computer system 110 and/or one or more of the user devices 115 may receive one or more updated responses from the user device 115 with respected to the change of the measure. The computer system 110 and/or one or more of the user devices 115 may generate an update response graphic for the user device 115 to reflect the updated response.

Some embodiments of system 100 may be configured such that the computer system 110 and/or one or more of the user devices 115 may determine one or more updated votes of one of more members from the political body with regard the change with respect to the one or more measures. The computer system 110 and/or one or more of the user devices 115 may generate a digital update stages graphic to reflect the relationship between the updated votes of the one or more members and the updated responses from the user with respect to the plurality of stages.

The computer system 110 and/or one or more of the user devices 115 may generate a digital aggregate results graphic reflecting the aggregate results of the user compared to the one or more members of the user with respect.

Some embodiments of system 100 may be configured such that the computer system 110 and/or one or more of the user devices 115 may protect the user votes from being identified by an administrator of computer system 110 or other individuals different from users 120.

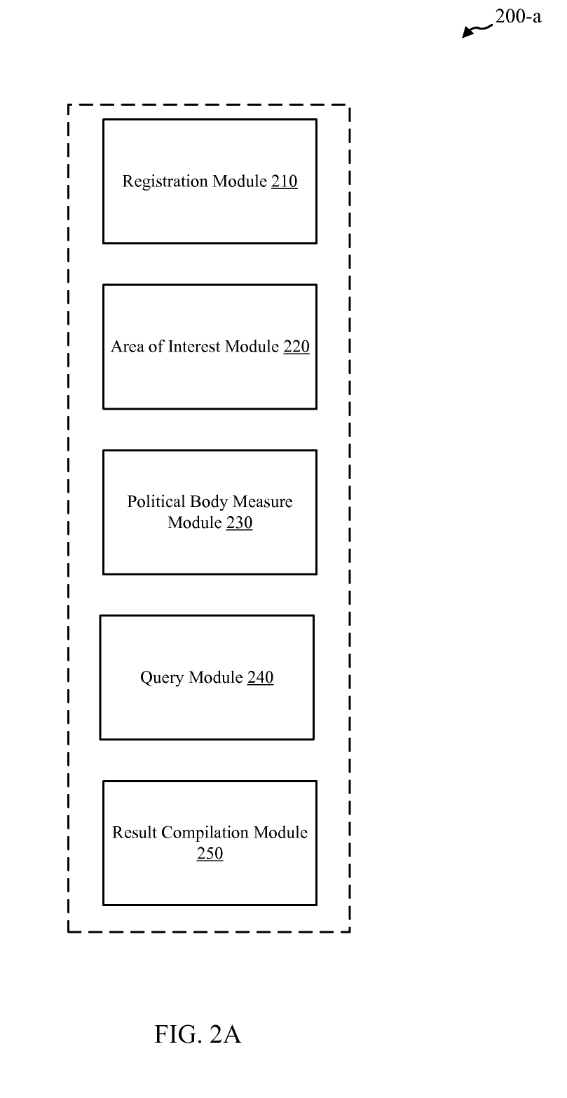

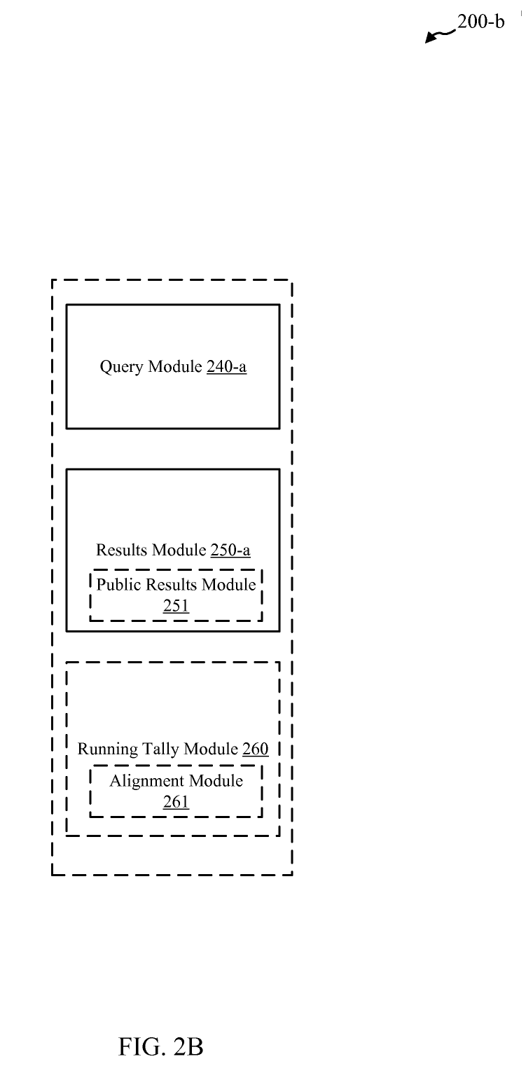

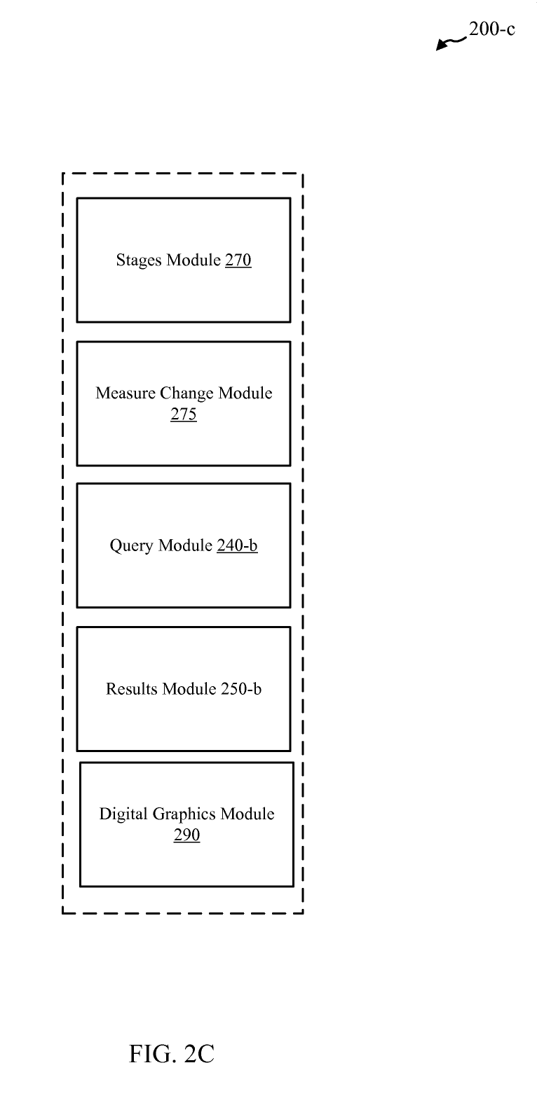

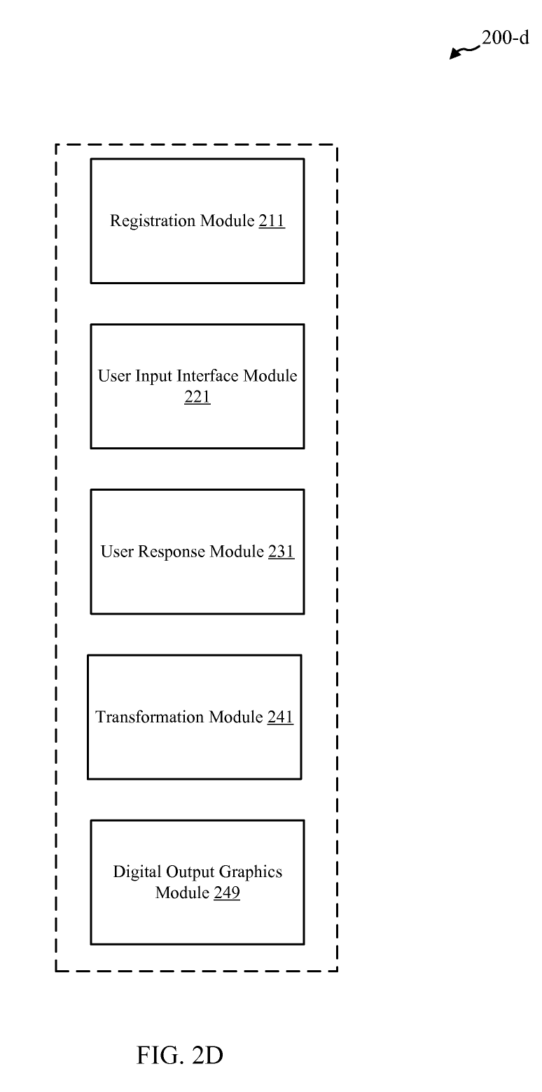

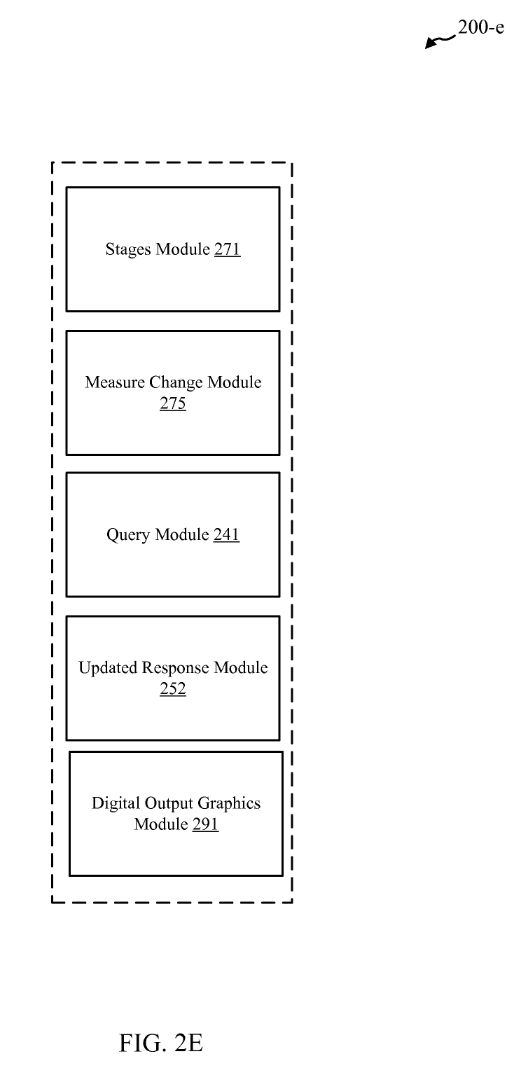

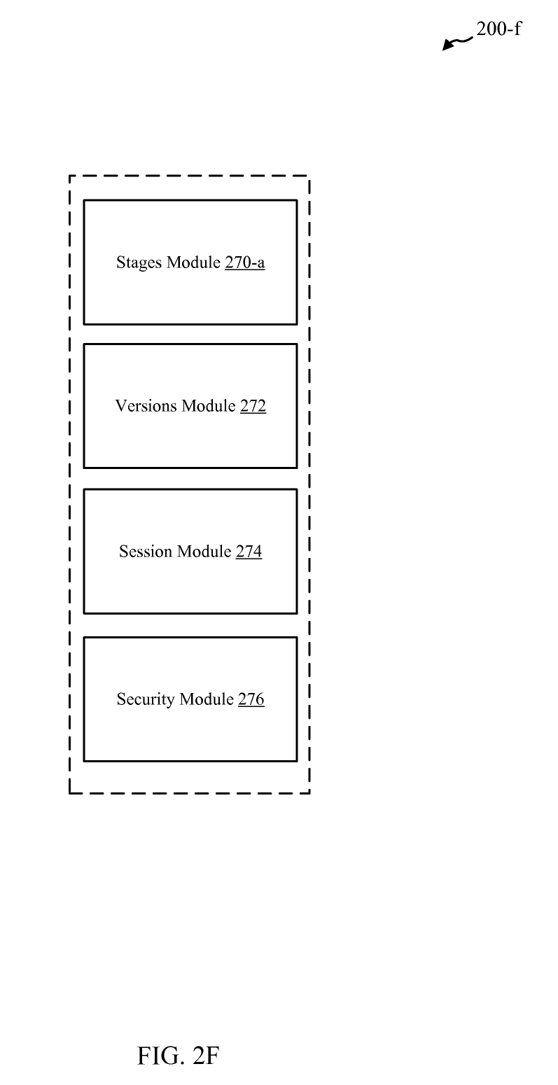

A general overview of a system 200-a for gathering and/or providing public opinion information in accordance with various embodiments is provided with FIG. 2A. The modules of system 200-a may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. Alternatively, the functions may be performed by one or more processors in general. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the system 200-a. System 200-a may be an example of aspects of computer system 110 of FIG. 1.

System 200-a may include a registration module 210 configured to register multiple. The registration may include authenticating at least an age of each user, a geographic location of each user, a voter registration status of each user, a party affiliation, or a voter activity level of each user. System 200-a may include an area of interest module 220 configured to determine one or more areas of interest for each of the users. System 200-a may include a political body measure module 230 configured to identify at least one measure being considered by a political body related to at least one of the areas of interest for at least a subset of the multiple users. System 200-a may include a query module 240 configured to transmit at least one question to the subset of multiple users, wherein the at least one question relates to at least one of the measures being considered by the political body related to at least one of the areas of interest of the subset of the multiple users. The query module 240 may also be configured to receive one or more responses from the subset of multiple users regarding the at least one question related to the at least one measure being considered by the political body related to the at least one area of interest of the subset of multiple users. System 200-a may also include a result compilation module 250 configured to compile results based on the one or more responses from the subset of multiple users.

In some embodiments, system 200-a may be configured to utilize the above modules or include additional modules that may be configured to at least transmit compiled results to at least one member of the political body or one or more users from the subset of multiple users; determine one or more specific votes by one or more members of the political body with respect to the at least one measure; compare the one or more determined specific votes by the one or more members of the political body with the one or more received responses from the subset of multiple users; or transmit information related to the comparison to the individual users from the subset of multiple users.

In some embodiments, system 200-a may be configured to utilize the above modules or include additional modules that may be configured to at least disaggregate the compiled results based upon at least gender, age, party affiliation, or geographical information of the subset of multiple users; or provide publicly the disaggregated results. In some embodiments, system 200-a may be configured to utilize the above modules or include additional modules that may be configured to at least aggregate the compiled results based upon at least gender, age, party affiliation, or geographical information of the subset of multiple users; or provide publicly the aggregated results.

In some embodiments, system 200-a may be configured to utilize the above modules or include additional modules that may be configured to at least determine information regarding individual users from the subset of users at least at a precinct level, a city level, a county level, or a school district level. In some embodiments, system 200-a may be configured to utilize the above modules or include additional modules that may be configured to at least generate a map based on the compiled results; or present the generated map of results.

A general overview of a system 200-b for gathering and/or providing public opinion information in accordance with various embodiments is provided with FIG. 2B. The modules of system 200-b may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. Alternatively, the functions may be performed by one or more processors in general. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the system 200-b. System 200-b may be an example of aspects system 200-a of FIG. 2A. System 200-b may be an example of aspects of computer system 110 of FIG. 1.

In some embodiments, query module 240-a may be configured to gather public opinion by querying users on specific legislative questions or issues. This may allow officeholders at the federal, state, and/or local level to learn the preferences and/or opinions of their constituents before they cast a vote or take a position on the issue in question. A results module 250-a may be configured such that the public opinion information may be received, compiled, aggregated, and/or distributed back out to the user and/or to the public in general in a timely fashion. In some embodiments, the results module 250-a may include a module such as public results module 251 that may be utilize to distribute different results from the results module 250-a.

Some embodiments of system 200-b may include a running tally module 260 that may be configured to keep a running tally of how closely aligned the public and/or elected official's positions and/or votes are with each specific users over time. In some cases, the information may be disaggregated in myriad ways to align with subscribers by precinct, neighborhood, city/county, house district, senate district, congressional district, by age, sex, etc. In some embodiments, the running tally module 260 may include a module such as an alignment module 261, which may be utilized specifically to determine alignment between public and elected official's positions and/or votes with respect to specific users.

Merely by way of example, after 16 months in office and facing a primary challenge, elected official A might be voting in alignment with subscriber #103 only 45% of the time based on their important issues, but with subscriber #1209 a much healthier 75% of the time. People may be able to use this data when determining whether to support elected official A. Some embodiments may also be able to aggregate this information for public consumption, by announcing on issues of “education” or “the environment,” an elected official A may reflect the subscribers viewpoints 65% of the time for certain precincts within the city of boulder, 50% of the time for the city of boulder in general, but only 40% of the time for countywide resident subscribers, etc.

Some embodiments of system 200-b may utilize user authentication. For example, each voting aged user (e.g., 18+ only) may be uniquely identifiable, based on geographic location for example, and matched to public voter registration information if available. Some embodiments may provide for posting commentary about their position on issues or their support or opposition to how elected officials might be voting on their behalf. In some embodiments, interaction may be considered an option.

Some embodiments of system 200-b may allow for a multi-tiered service model based on cost. For example, a Level 1 may provide a free, basic version of the service, offering the fewest opportunities for opinion gathering (for example, only 10 specific issues) and the least amount of information. Level 2 may provide cost a minimum amount per month, for example $1, and offer between 11-25 questions or issues and more interaction and graphics, a lengthier explanation of issues, etc. Level 3 may provide the 26-50 question range with the most bells and whistles, the prettiest graphics, the most detailed analysis or explanation of issues, more opportunities for interaction, etc. for $10 a month.

Some embodiments of system 200-b may include not selling or otherwise divulging any information about its users, nor make user information available to anyone. In some cases, revenue may not be made from selling advertisements or by allowing other organizations to post on our site, etc. In some cases, revenue source may include subscriber fees per user may depend upon level of service. In some cases, brand loyalty, user comfort and/or satisfaction, and/or increased interactive service between different levels for subscribers will be relevant.

Some embodiments of system 200-b may break down users geographically by precinct to establish state house and senate districts, and/or congressional districts. Some embodiments may be able to distinguish users by more local subdivisions including counties, city council districts/wards, school board member district boundaries, special district boundaries, etc. Some embodiments may utilize a GPS capability of cell phones as part of the overall authentication process. Some embodiments may provide authentication by proxy via the state's voter registration lists and/or another process of authentication. Some embodiments may be able to handle non-registered voters.

Some embodiments of system 200-b may include different database structures that may include different fields regarding different authenticated users including, but not limited to, name, date of birth, address, sex, house district, senate district, congressional district, precinct, subjects, and/or areas of interests. Some embodiments may include databases that may include bill numbers, bill titles, bill subjects, bill summaries, bill details, and/or bill texts. Users and/or subscribers may weigh in and indicate preferences for or against (or don't know/don't care) for their chosen bills.

Some embodiments of system 200-b may involve tracking specific legislation at a state capitol and/or a federal capitol. Some embodiments may track actions being voted upon a town, city, county, and/or school district level. Some embodiments may summarize information regarding specific legislation or matters being considered by a political body and upload the information in a timely fashion in order to be used to gauge the opinion of users. That information may be broken into subjects and/or topics from which the public can choose to weigh in, based on previously indicated user and/or subscriber preferences (e.g., guns, abortion rights, the environment, taxes, etc.) established during the authentication phase.

In some embodiments of system 200-b, based on a level of the user, the poll questions may be pushed out to user and/or subscribers in order to elicit a response and gather feedback within a designated timeframe. These time frames may vary, for example, 1 hour, 3 hours, 6 hours, 12 hours, 24 hours, 36 hours, etc. These times frames may help to ensure public posting in a timely fashion. In some cases, before final vote is taken on the legislation, ordinance, etc. by the elected official, there may be times when this is not possible, but the public posting may occur as soon as technically feasible.

In some embodiments of system 200-b, the polled user and/or subscriber information may be disaggregated down to different levels, such as a precinct level or lower level. In some cases, this disaggregated information may provide a useful model and/or tool for where and how citizens are responding to specific questions of public policy compared to how those issues are actually voted on by their own elected officials. Polled information may not be publicly released to correspond to any individual user and/or subscriber. Polled information may be released in aggregated or disaggregated format, which may not be individually identifiable.

Some embodiments of system 200-b may provide a map feature that may aggregate and/or disaggregate user and/or subscriber preferences, which may show alignment or non-alignment with elected officials voting actions. For example, an interactive map of the whole state may have precinct specific information broken down by issue, which may then be aggregated into state house and senate districts, then congressional districts, etc. User and/or subscribers may see how elected officials align with their responses, the number of other user and/or subscribers located in other precincts, the percentages of alignment, and/or the number of issues tabulated, etc. In some embodiments, the map features may include interactive type maps that may utilize color scales (e.g., blue for cold, yellow for warm, red for hot, shades of grey, etc.) Some users and/or subscribers may expect more interactivity and/or details for graphics and functionality, which may be provided in different embodiments. Some maps can be used by the general public—even non user and/or subscribers—and others may only be available to users.

Some embodiments of system 200-b may provide more interactive opportunities for users to contact their legislators and political officials about their opinions on issues, send correspondence to newspapers, post comments in public domains, start their own petitions or ideas for legislation, and/or interact with other users, etc. from our platform. In some embodiments, users may be able to link to websites of elected officials and other public or government sites that connect them to specific bills or information about issues, candidates, organizations, and/or outside sources, etc. Some embodiments of system 200-b may provide for links to other petition sites (e.g., change.org, moveon.org, Care2petition.org, etc.), political parties, news media, etc.

A general overview of a system 200-c for gathering and/or providing public opinion information in accordance with various embodiments is provided with FIG. 2C. The modules of system 200-c may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. Alternatively, the functions may be performed by one or more processors in general. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the system 200-c. System 200-c may be an example of aspects system 200-a of FIG. 2A and/or system 200-b of FIG. 2B. System 200-c may be an example of aspects of computer system 110 of FIG. 1.

System 200-c may include a stages module 270 that may be configured for determining multiple stages with respect to the one or more measures. A digital graphics module 290 may be configured to generate digital stages graphic for the user device to reflect the multiple stages along with at least the responses of the user or the votes of the one or more members of the political body.

In some cases, system 200-c may include a measure change module 275 that may be configured to determine whether a change with respect to at least one of the one or more measures may have occurred. One or more queries may be transmitted from a query module 240-b to the user device of the user that reflects the change of the measure. One or more updated responses may be received from the user device with respected to the change of the measure utilizing a results module 250-b. An update response graphic may be generated for the user device to reflect the updated response utilizing the digital graphics module 290.

In some embodiments, one or more updated votes of one of more members from the political body may be determined with regard the change with respect to the one or more measures utilizing the results module 250-b. A digital update stages graphic may be generated to reflect the relationship between the updated votes of the one or more members and the updated responses from the user with respect to the multiple stages utilizing the digital graphics module 290.

A general overview of a system 200-d for gathering and/or providing public opinion information in accordance with various embodiments is provided with FIG. 2D. The modules of system 200-d may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. Alternatively, the functions may be performed by one or more processors in general. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the system 200-d. System 200-d may be an example of aspects of user devices 115 of FIG. 1.

A registration module 211 may be configured for transmitting a registration digital signal from a user device to register a user at a computer system. An input user interface module 221 may be configured to generate an input user interface for the user device of the user to determine one or more measures of interest to the user being considered by a political body. A user response module 431 may be utilized to transmit one or more response digital signals from the user device regarding one or more response related to the one or more measures being considered by members of the political body of interest to the user.

A transformation module 241 may be utilized to transform the one or more responses from the user device and one or more votes of the one or more members from the political body to reflect the relationship between the one or more responses of the user and the one or more votes of the one or more members of the political body. A digital output graphic module 249 may be utilize to generate a digital output graphic for the user device to reflect the relationships between the one or more responses of the user and the one or more votes of the one or more members of the political body with respect to the one or more measures.

Some embodiments of system 200-d may be configured for transmitting the one or more responses from the user device to one or more devices of the one or more members of the political body.

A general overview of a system 200-E for gathering and/or providing public opinion information in accordance with various embodiments is provided with FIG. 2E. The modules of system 200-e may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. Alternatively, the functions may be performed by one or more processors in general. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the system 200-e. System 200-e may be an example of aspects of user devices 115 of FIG. 1. System 200-e may be utilized in conjunction with and/or may reflect aspects of system 200-d of FIG. 2D

System 200-e may include a stages module 271 that may be configured for determining multiple stages with respect to the one or more measures. A digital output graphic module 291 may be utilized to generate a digital stages graphic for the user device to reflect the multiple stages along with at least the responses of the user or the votes of the members. A measure change module 276 and/or query module 241 may be configured for receiving one or more queries to the user device of the user that reflects a change of one or more measures. One or more updated responses may be transmitted from the user device with respected to the change of the measure utilizing the updated response module 252. An update response graphic may be generated for the user device to reflect the updated response utilizing the digital output graphics module 291. Some embodiments may include configuring the digital output graphics module for generating a digital update stages graphic to reflect the relationship between updated votes of the one or more members and the updated responses from the user with respect to the multiple stages. Some embodiments of system 200-d may include generating a digital aggregate results graphic reflecting the aggregate results of the user compared to the one or more members of the user utilizing the digital output graphics module 291.

A general overview of a system 200-f for gathering and/or providing public opinion information in accordance with various embodiments is provided with FIG. 2F. The modules of system 200-f may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. Alternatively, the functions may be performed by one or more processors in general. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the system 200-f System 200-f may be an example of aspects of system 200-a of FIG. 2A, system 200-b of FIG. 2B, and/or system 200-c of FIG. 2C; one or more of the modules of system 200-f may be utilize in conjunction with these other systems. System 200-f may be an example of aspects of computer system 110 of FIG. 1. System 200-f may include a stages module 270-a, a versions module 272, a session module 274, and/or a security module 276.

In some embodiments, stages module 270-a be utilized with respect to one or more stages of one or more measures before a political body. For example, different bills or measures may get introduced into the political body, such as either of chamber of assembly (e.g., a House of Representatives, a Senate, a city council, etc. Bill or measure stages may be the different phases a bill or measure undergoes before it gets either passed or killed. A bill or measure may have a maximum number of stages. Merely by way of example, a bill or measure may have maximum of 12 stages, though other maximums may be utilized. Members of the political body, such as legislators, council members, etc, and users may vote on bill or measure stages.

When a bill or measure gets introduced into a political body, such as either of the chambers, it may go through the different stages. The following provides on example of a bill or measure that may have up to 12 stages. For stages 1-3, a bill may stay in the originating chamber, such as a house or senate. The respective chamber members may vote on one or more of the stages of the bill (i.e. stages 1-3). The bill may get passed to the other chamber once members are done with voting on 3 stages. For stages 4-6, the bill may stay in the other chamber. The respective chamber members may vote on each stages of the bill (i.e. stages 4-6). If bill is not passed or is killed until it reaches stage 6, then the bill may again be passed to the originating chamber. For stage 7, the bill may get voted again in the originating chamber. For stages 8-12, either chamber members may be allowed to vote on the bill. During the voting phase, at any stage, a bill may get passed or killed. Once passed or killed, bill stages may not get created. Once the bill is passed or killed, members of the political body, such as legislators, may not vote further on the bill.

In some embodiments, and administrator may be responsible for bill stages. The administrator may create a bill and its respective stages. In some embodiments, the stages module 270-a may facilitate this process. The administrator may login to the computer system and open a new bill page, which may be represented through an interface, which may be a GUI in some cases, or other electronic interface. The administrator may provide details regarding the bill and save the bill and its details. In some cases, the computer system may retrieve the bill details from another computer system or from another part of the computer system, such as from a computer database that includes bill details. The newly created bill may be treated as stage 1 and/or version 1.

From stage 1 for a bill, the bill may get staged and the administrator or the computer system create stage 2 utilizing the stages module 270-a. The administrator may open the respective bill page on the computer system. In some cases, He a status dropdown may be provided on the bill page, which may be represented as a webpage or other digital interface format. The administrator may select a stage option from the dropdown in some cases, where the administrator may enter stage related details. A start date and/or end date may be provided for the bill stage; in some cases, the administrator may provide these details or the computer system may determine from a database. In some cases, votes on the bill may be visible. A carry forward votes option field (or a check box in some cases) may be provided from the bill page for the bill stage. In some cases, an update bill button may be selected, which create a bill stage 2. These steps may be repeated to create further bill stages in some cases.

Votes of members of the political body, such as legislator votes from house or senate members, may be entered into the system in different ways, including through input from an administrator or through the computer system retrieving this information from a database.

Votes from a member of a political body with regard to one or more stages of the bill or measure may be entered into the computer system in a variety of ways. For example, an administrator may login to the computer system. The administrator may click on a link or income related for legislator votes, for example, which may be under a drop down application menu. Once the page opens, the administrator may create votes for the legislator, such as a house representative or senator, for a particular bill. In some cases, the administrator may select category and/or sub-category from a drop down menu for the bill or measure. The bill or measure may get pre-loaded in the bill listing; the administrator may select the bill. In some cases, the administrator may to select the legislator for which he or she may want enter votes (e.g., a house bill on stage 2 may not need to have senate votes entry created). Once a legislator or member of the political body has been selected, the administrator may a registration button, which may create a new entry to allow the administrator to enter the legislator's votes; in some cases, the computer system may be automated to gather this data from a computer database and enter it into the computer system for the legislator. In some cases, a page may be loaded where the administrator may be able to view the members of the political body, such as house representatives, senators, council members, etc.) Against one or more of the members of the political body, the administrator and/or the computer system may enter votes on one or more bill stages. Different vote options may be utilized such as Yes, No, Absent, or Excused, for example. Once a bill or measure stage is created within the computer system, votes of the one or more members of the political body may be entered into the system.

Different embodiments may provide for users to interaction with the tools and techniques for gathering and/or providing public opinion information. For example, a user may register with the computer system; the user may login to the system once they have registered with the system. The user may select bills or measures, which may be of interest to the user, for voting. In some cases, the user may confirm his or her bill or measure selection(s). In some cases, once the user confirms one or more selections, the user may be allowed to vote on the respective bills or measure.

In some cases, a voting phase may be open for a bill or measure during which the user may vote on a current stage of the bill or measure. If the user has voted previously on the respective bill or measure, and the votes were carry forwarded, the user may be able to see his or her votes on the progressing bill or measure stages. For carry forwarded votes, the user may be able to view a notification message on a dashboard or other electronic means, which may informing the user that his or votes were carry forwarded. In some cases, the user may be able to change his or her vote on the current bill stage only once. When a user votes on a bill or measure, he or she may be presented a confirmation box to confirm his or vote. Once a vote is confirmed, the user may not be allowed to change his or her vote in some cases.

Some embodiments may provide for user notifications. For example, once a bill or measure has been staged, a voting phase may get created for a bill or measure. This may be applicable in some cases where a carry forward option may not have been selected. For users who may have selected a respective bill or measure, a notification email may be sent. For example, this may occur when a carry forward option has not been selected. This email may provide the one or more users a voting reminder for the users to vote on the staged bill or measure. In some embodiments, the one or more users may be able to view the voting updates on a webpage, such as a dashboard, when the user logs into the system.

Some embodiments may involve different acceptance criteria. For example, an administrator and/or the computer system may be able to create bill stages. Users may able to vote on bill stages. The administrator and/or the computer system may be able to enter votes from the members of the political body.

In the example provided above that may involve up to twelve stages, for stages 1, 2, 3, 7, the administrator and/or computer system may be able enter votes for the originating chamber members. For stages 1, 2, 3, 7, the administrator and/or computer system may not be able to enter votes for the other chamber members. For stages 4, 5, 6, the administrator and/or computer system may be able to enter votes for the other chamber members. For stages 4, 5, the administrator and/or computer system may not be able to enter votes for the originating chamber members. For stages 8, 9, 10, 11, 12, the administrator and/or computer system may able to enter votes for either of the chamber members.

Some embodiments may utilize the versions module 272. For example, during a session of a legislative body, bills or measures may get introduced. For example, a bill or measure may be introduced to the legislative body, such as a city council; in another example, a bill or measure may be introduced into one of two houses of the legislative body, such as a house or senate. Bill or measure versions may be the different versions a bill or measure as undergoes before it gets either passed or killed. A bill or measure may have multiple versions; the version may relate to the stages of the bill or measure. Versions are the tangible changes (e.g., small edits) to the bill or measure. Members of a political body and/or users may not vote on bill or measure versions in some cases.

Merely by way of example, consider a state assembly that includes a house and senate. A bill at the state assembly may have multiple stages or versions. For example, a bill may have a maximum of 12 versions, though the number of versions or stages may be more or less. When a bill or measure gets introduced in either of the chamber and goes through minor changes, a new version may be created utilizing the versions module 272. In general, users and/or member of the political body may note vote on versions. A bill or measure may undergo multiple stages while progressing across chambers, the version may remain constant. For example, a bill or measure on stage 4 may be on version 1. When a bill or measure reaches stage 7, for example, it may mean that there is a 2nd version of the bill in existence somewhere through the process, but that 2nd version may have been created at an early stage 4, and it might have been a minor change. In some embodiments, versions may be visible under on a version tabs on a Dashboard or website for user login. Users in some cases may not get notifications when a version in created.

In some embodiments, an administration may be responsible for bill or measure versions, which may be facilitated by the versions module 272. The administrator and/or computer system may create a bill or measure its respective versions utilizing the versions module 272, for example. Different steps may be involved to create a version of a bill or a measure. For example, a version 1 of a bill ore measure may be created as follows, but other ways to be utilized. An administrator may log into a computer system and open a new bill or measure page. The administration and/or the computer system may upload or link to the actual bill or measure at the political body, such as on a General Assembly or City Council homepage, and the official summary and/or fiscal note. These links may be visible and accessible to the user on a bill or measure versions tab. The newly created bill or measure may be treated as version 1 and/or stage 1.

Other versions of the bill or measure also be created. For example, a bill or measure with a version 1, its text may get changed and the administrator and/or computer system may create a version 2. For example, the administrator may open the respective bill or measure page on the computer system. The administrator may see a status dropdown on the page. The administrator may select version option from the dropdown. Some embodiments may provide an edit option from a status dropdown for changes to the bill or measure. The administrator may enter the modified details. These details may be visible and accessible to the user on the bill or measure versions tab. In some cases, the versions may or may not include a start date, an end date, votes on the bill being visible, and/or carry forward vote option fields or taps from a webpage. In some cases, an update bill or measure button or tab may be provide, which may create another version, such as a version 2, for the bill or measure. On a bill or measure page, an administrator may be able to view the version of the bill or measure created. In some cases, a list for all earlier versions of the bill or measure may be provided. One of more of these steps may be utilized to create further bill versions.

The user may register with the computer system and may login. The user may select bills for voting. The User may confirm his or her bill selection. Once a user confirms the selection, he or she may be allowed to view all the versions of the respective bill or measure that may have been added to the computer system. When a user clicks on version tab on the dashboard or website, the user may be able to view all the versions of the bill or measure.

In some cases, a bill or measure stage number and a bill or measure version number may be the same. In some cases, a version number may not be great than a stage number. They may be same in some cases. For example, in some cases, a bill or measure on stage 7 may have a version number great than one.

Different acceptance criteria may also be utilized. For example, an administrator and/or computer system may create bill or measure versions. Users may be able to view bill or measure versions. A bill or measure on a certain stage, such as stage 7, may have a version number great than one.

Some embodiments may utilize a session module 274. The session module 274 may be utilized to help enable users to provide responses with respect to a past, current, or future session of a legislative body. Users may be able to select a number of bills or measures and vote on the bill or measure. This may be done with respect to different stages of the bill. For example, after a session of a legislative body, a user may be able to vote on the last stage of a bill or a measure. For a future session of the legislative body, they may be able to vote on a first stage of a bill or a measure. During a session of the legislative body, the user may be able to vote on one or more stages of the bill or measure.

Merely by way of example, when a user votes on a bill or measure stage, his or her vote may get duplicated against a previous stage of the bill or measure such as when the user is voting with respect to a past session of the legislative body utilizing the session module 274. In some embodiments, users may not get charged for voting on these bills or measures for a past session. In some cases, a user who joins before a current session gets over or after a next session starts may not get to use this feature. In some embodiments, a user may join or register with the computer system after a current session of the political body is over and next session has not yet started. In some cases, the user may join as a free or other user. When the user joins the system, bills ore measures added during the respective session may have been passed or killed. One the user logs into the system, the user may view a landing page. This page may have information explain to the user the details of a test drive (which may include static text sent earlier). A user may click a button or tab to get started, where the user get navigate to webpage, such as a Dashboard page. The user may select different bills or measures, which may have a limit (e.g., 25 bills or measures). After the user confirms his or her selections, the user may be allowed to vote once on each of the selected bills or measures. The user vote(s) may get registered on the last stage of the bill or measure. Depending on the user's votes, user may be able to view his or her voting profile and/or see how his or her members of the political body have voted on the same bill or measure.

Different numbers of bills or measures may be uploaded within the computer system for different sessions or time periods for the political body. For example, a set number of bills or measures from a past time period may be uploaded. The number of bills or measures uploaded may depend on how many bills or measures are introduced at the political body. In general, for a past time period or session, a user may be able to view a fixed number of bills or measures. For a current or future session or time period, the number bills or measures may increase during the session or time period.

Merely by way of example, a user may be able to vote on bills or measures from a past session or time period facilitated by the session module 274. In general, a passed bill or measure may need to pass through at least a certain number of stages (e.g., six stages). In some cases, when a user votes on a passed bill or measure, the user's votes may get registered on the last stage of the bill or measure. The vote may get duplicated for the other chambers of the political body (e.g., a house or senate vote) in past (e.g., if a user votes against a house representative, the user's vote may get duplicated against previous vote of a senator, or vice versa). When a user votes on a killed bill or measure which was killed after a specific stage (e.g., after stage 3), the user's vote may get registered on the last stage of the bill or the bill. The vote may get duplicated for the other chambers of the political body (e.g., a house or senate vote) in past (e.g., if a user votes against a house representative, the user's vote may get duplicated against previous vote of a senator, or vice versa). When a user votes on a killed bill or measure which was killed before a certain stage (e.g., stage 3), the user's vote may get registered on last stage of the bill or measure; the vote may not get duplicated. If a user votes on a passed or killed bill or measure, the user's vote may get registered on the last stage of the bill or measure; the vote may get duplicated for the other chambers of the political body (e.g., house or senate vote) in past (e.g., in case the member of the political body from another chamber was absent or excused from the vote, the user vote may get duplicated against absent or excused vote of the member of the political body).

As described above in general, a user joining or registering with the system after current session or time period gets over and before the next session or time periods starts may get a list of bills that may have been uploaded during the current session or time period. These bills or measures in general would have been passed or killed. In general, the user may be able to select up to a certain number of those bills. The user may vote on the last version of the bill. The user votes may get duplicated against a previous stage of the bill.

Some embodiments may utilize a security module 276. The security module 276 may be configured for protecting the user votes from being identified by an administrator of the computer system. This may be done in numerous ways, such as encrypting the user's voting information, segregating the user's voting information from access by a administrator or other individual different from the user, and/or removing user information with respect to the user's votes when viewed by an administrator or other individual different from the user. Other techniques may be utilized to protect to the user's votes from by identified by the administrator or other individuals different from the user.

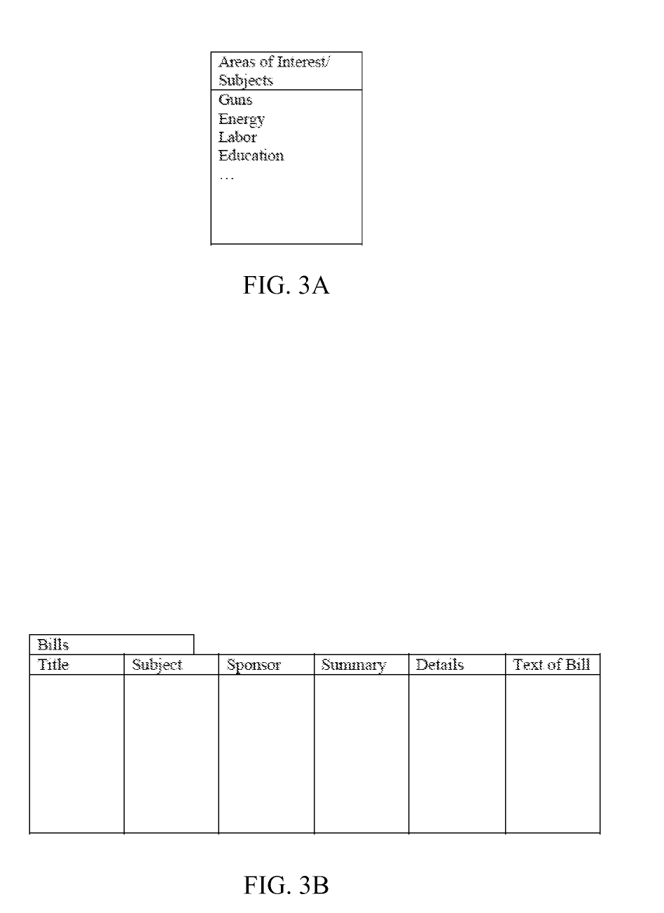

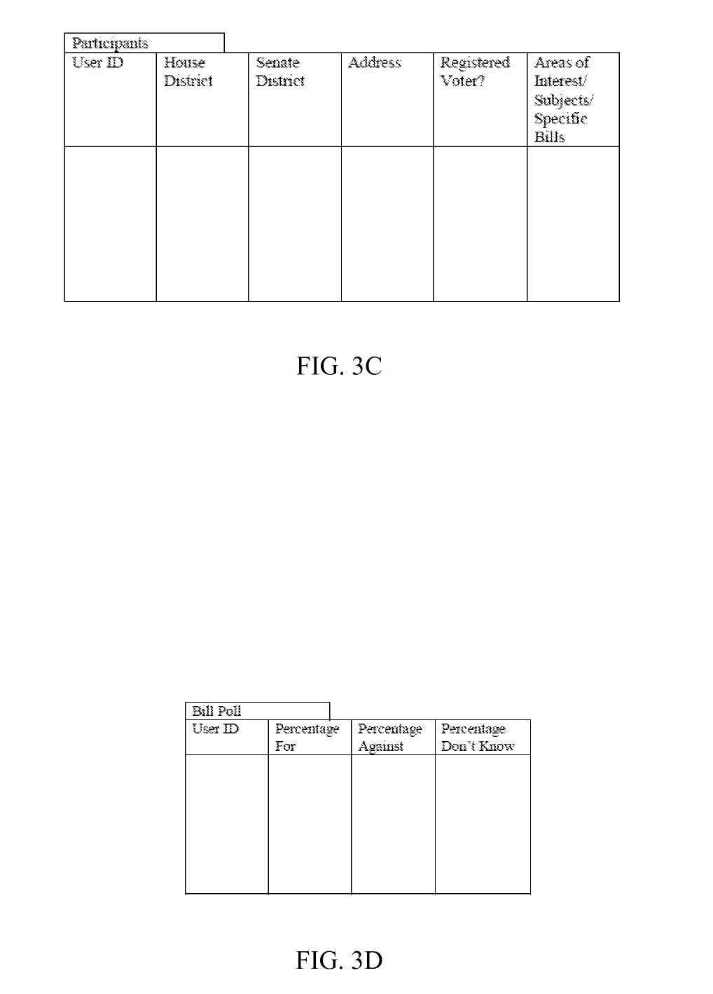

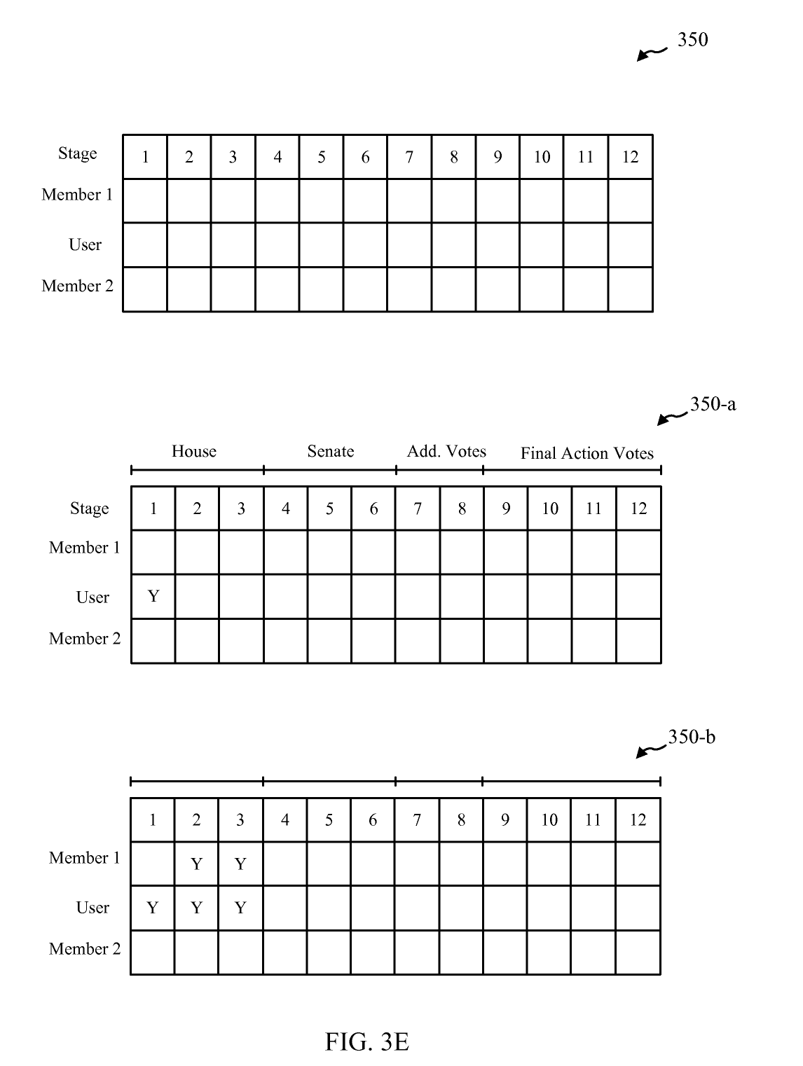

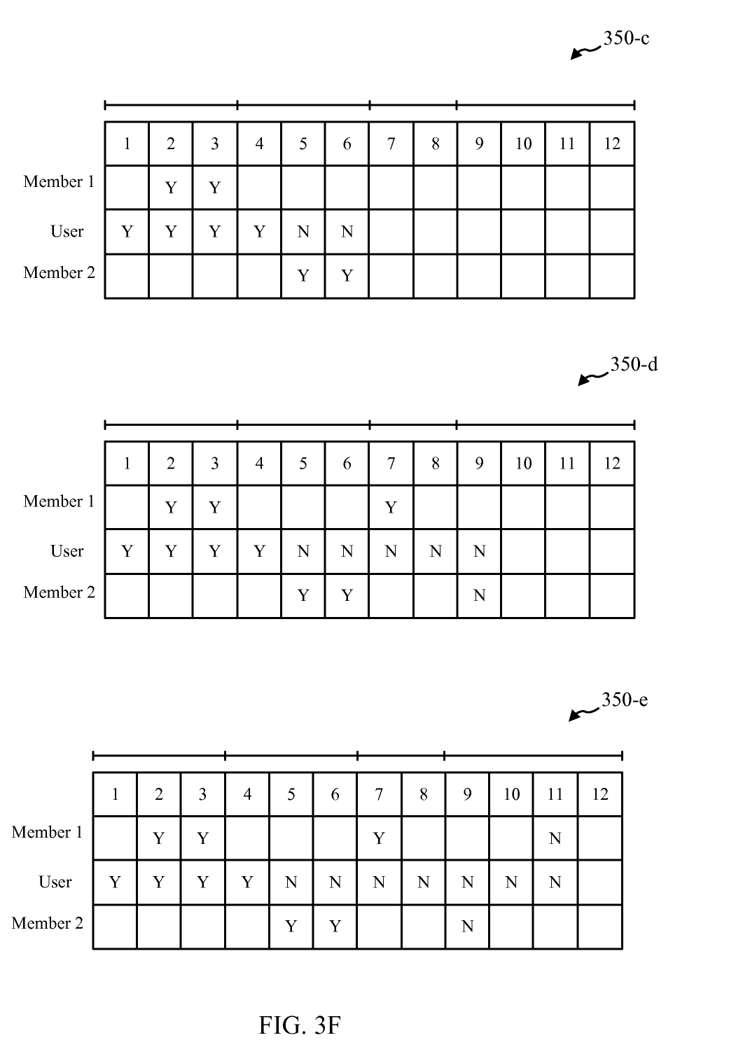

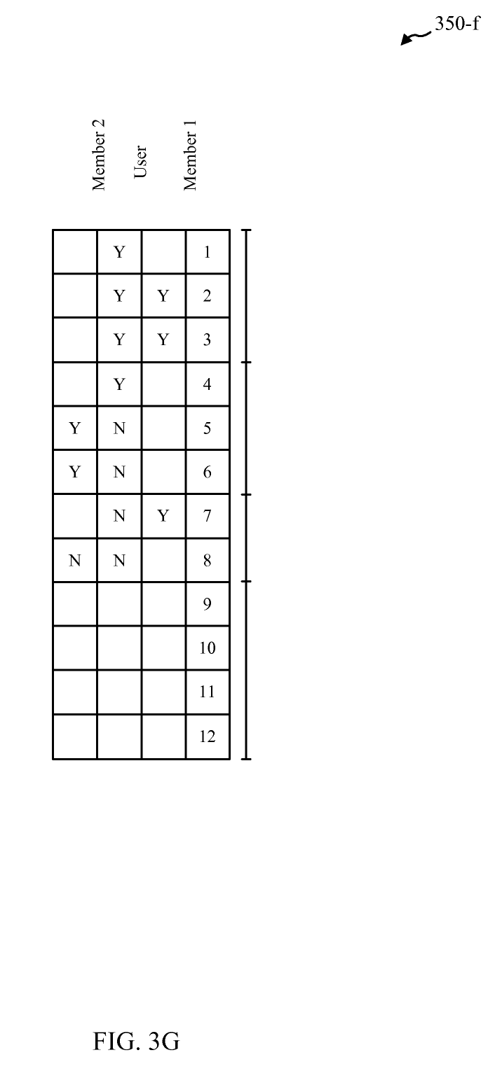

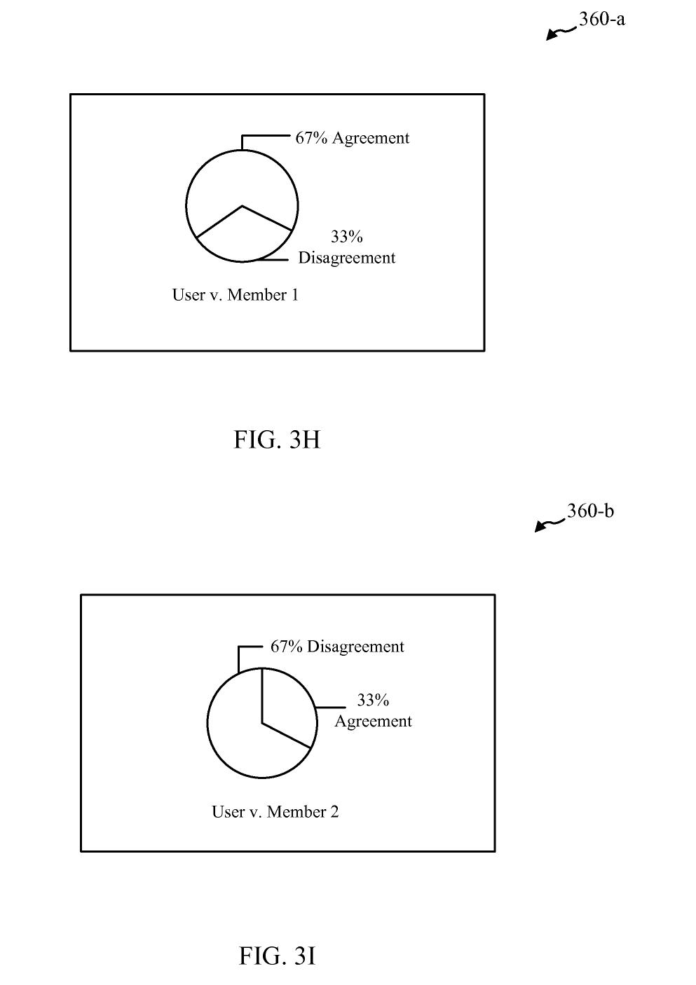

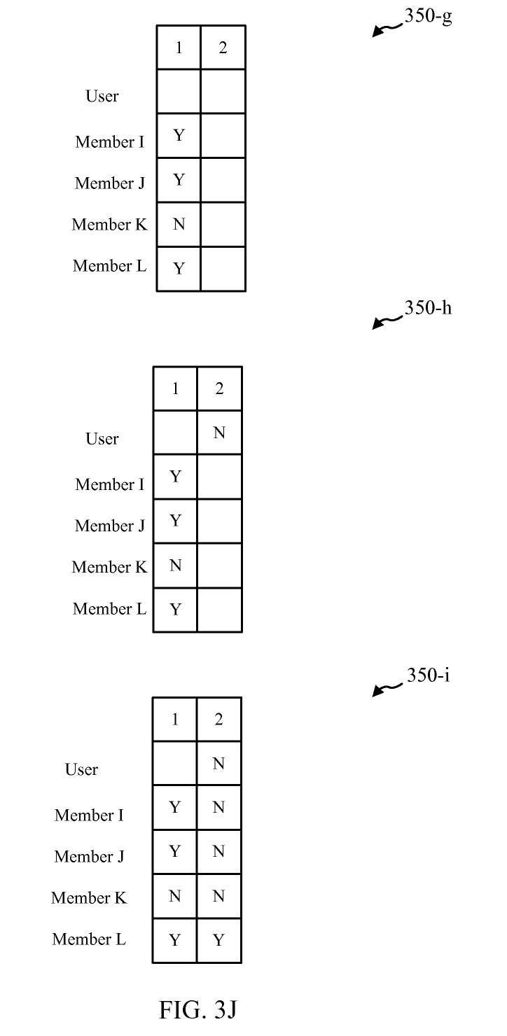

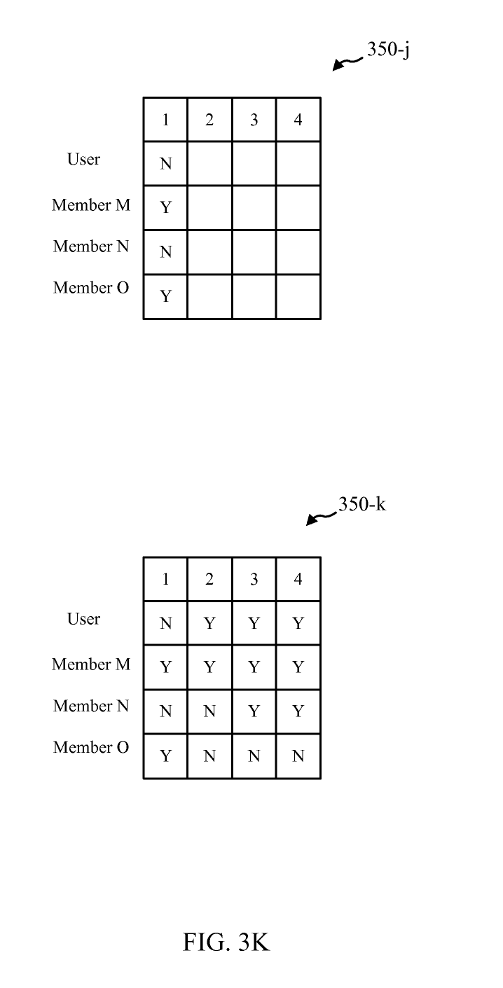

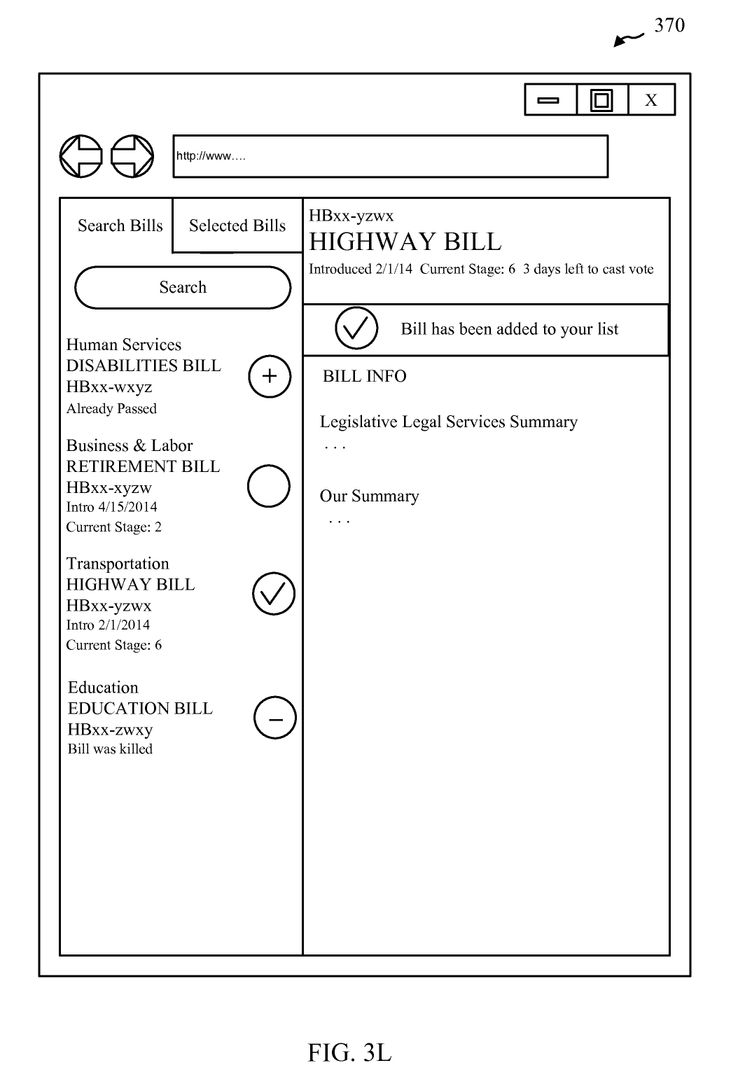

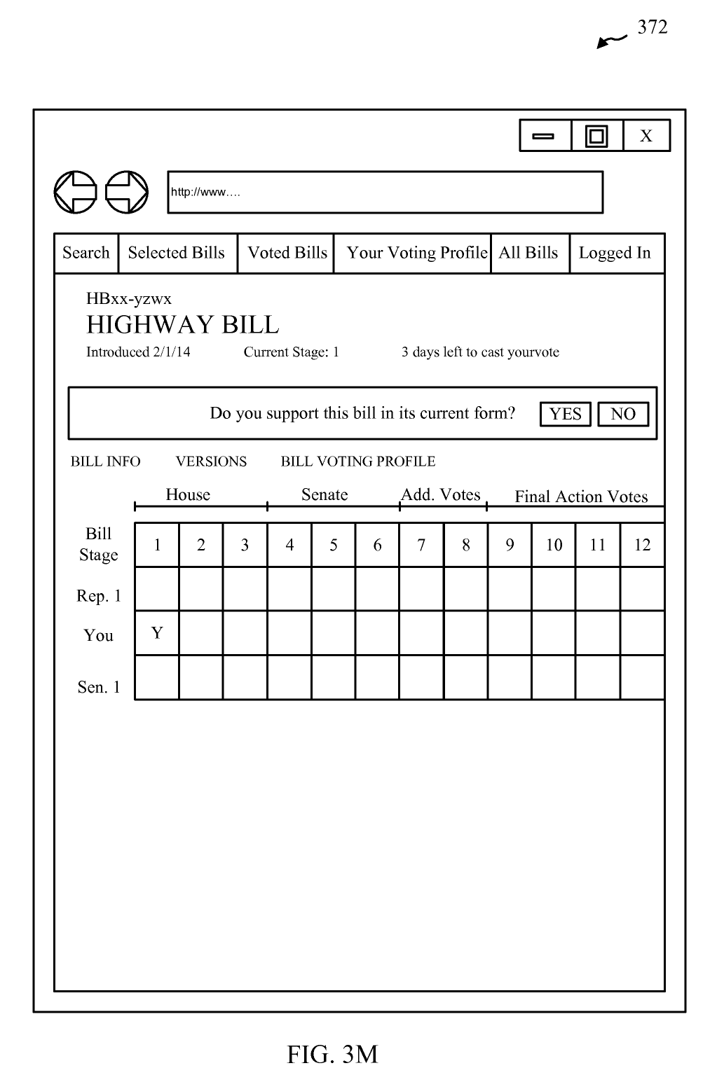

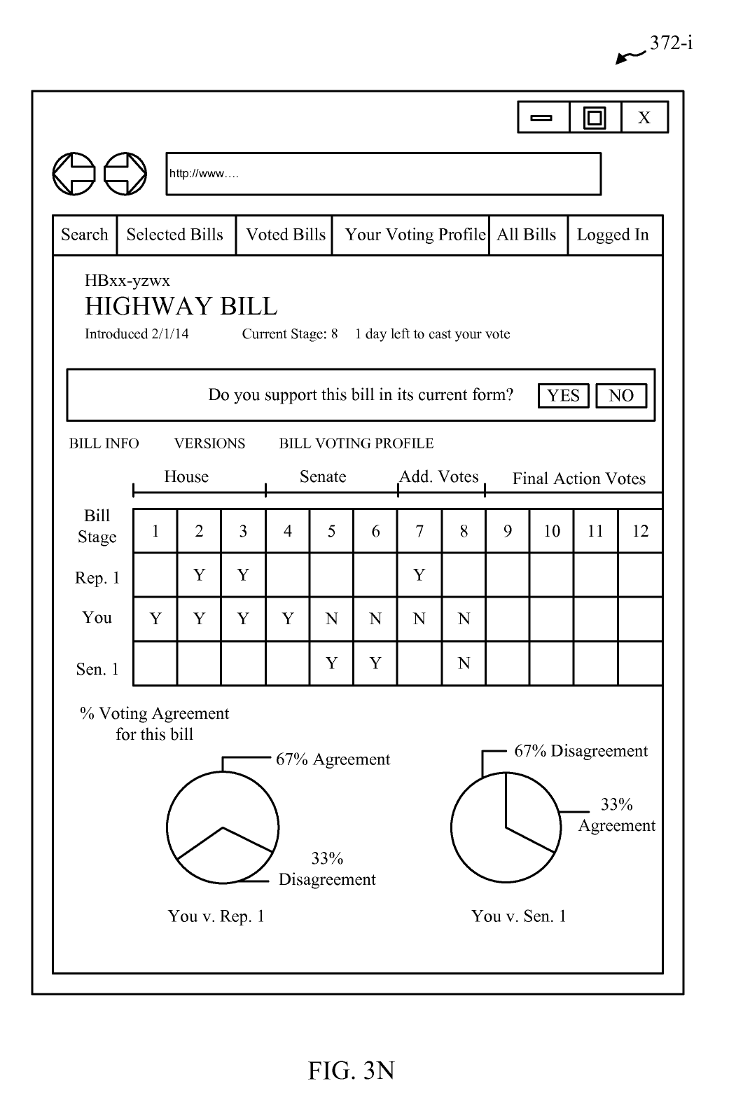

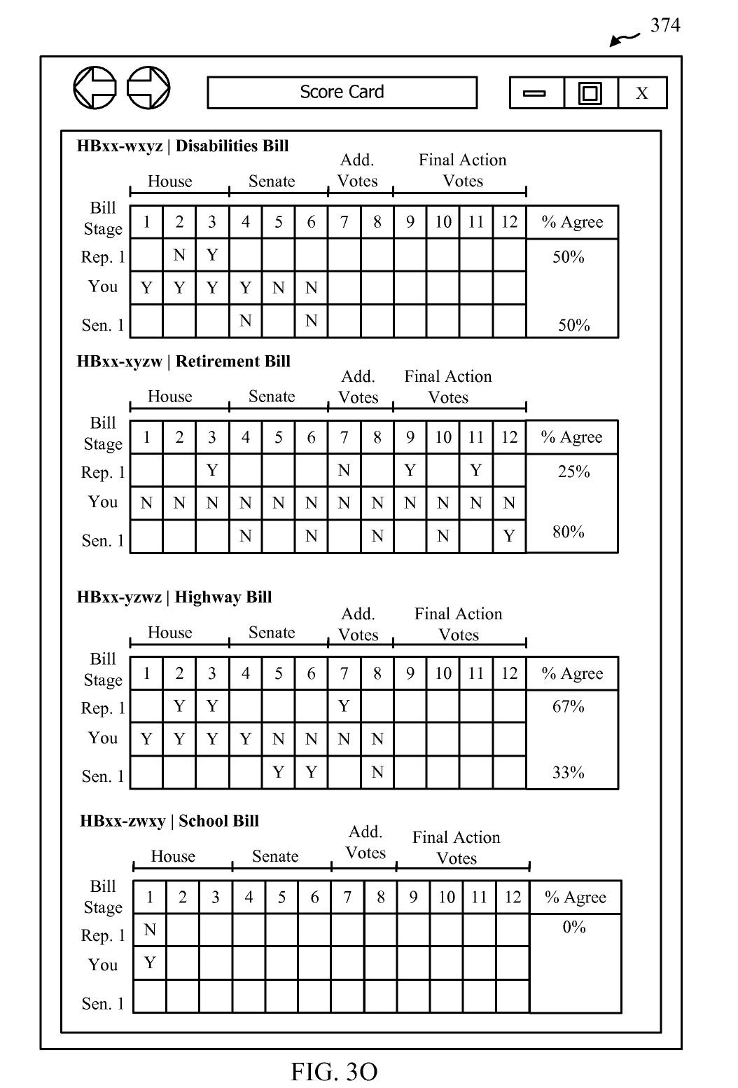

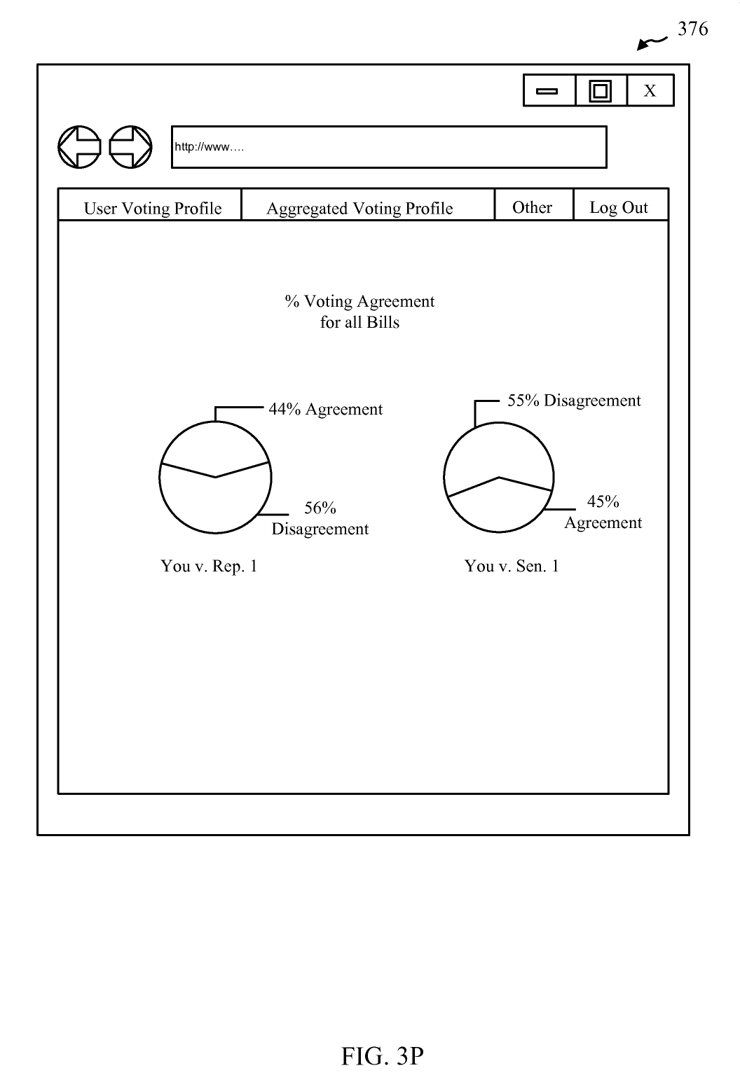

Some embodiments may include different database structures that may include different fields regarding different authenticated users including, but not limited to, name, date of birth, address, sex, house district, senate district, congressional district, precinct, subjects, and/or areas of interests. Some embodiments may include databases that may include bill numbers, bill titles, bill subjects, bill summaries, bill details, and/or bill texts; more generally, these may be referred to as measure number, measure title, measure subjects, measure summaries, measure details, and/or measure texts, merely by way of example. Users and/or subscribers may weigh in and indicate preferences for or against (or don't know/don't care) for their chosen bills. FIGS. 3A, 3B, 3C, and 3D provide several different examples of different database structures that may be utilized by a variety of different embodiments; these database structures may be utilized by different systems, such as computer system 110 of FIG. 1, system 200-a of FIG. 2A, system 200-b of FIG. 2B, system 200-c of FIG. 2C, and/or system 200-f of FIG. 2F. For example, FIG. 3A shows an example of an areas of interest or subjects table, which may list a variety of areas of interest or subjects that different users may be interested in or that may be areas that cover one or more measures being considered by a political body. FIG. 3B shows a bills table, which may include information regarding different bills or measures being considered by a political body. The table may include a title, subject, sponsor, summary, details, and/or text of the bill. FIG. 3C shows a participants or user table. This may relate to authenticated users in some cases. The table, for example, may include user IDs. The table may also include information regarding the different districts that the user may be associated with, such a precinct, house district, and/or senate district, though other political subdivisions may also be included. The table may also include information regarding users' address, whether they are registered to vote, party affiliation, areas or subjects of interest, and/or specific bills or interest. FIG. 3D shows a bill poll table. This table may include information such as user IDs, percentages for a bill, percentages against a bill, and/or percentages that don't know with regard to a bill. These tables in FIGS. 3A-3D may include more or less columns or data. Other embodiments may utilize other tables with other information for the database.

Turning now to FIG. 3E, a measure chart 350 in accordance with various embodiments is provided with respect to a specific user and a specific measure; in some cases, the measure chart may be referred to as a digital graphic. The measure chart may reflect how the user views each measure as it passes through one or more stages. The user may respond utilizing a user device to provide their response or view on different bills or measures. The measure chart may reflect also how one or more members or a political body may vote on a specific measure over time as the measure passes through different stages; in this example. Chart 350 shows two possible members of the political body (Member 1 and Member 2), though some cases may include more or less members of the political body.

For example, it may be determined that the specific measure is of interest to the user. The bill may be divided into one or more stages that may reflect how the bill may pass through the political body. In this example, 12 possible stages are shown in the chart 350, though more or less stages may be utilized in some cases. The user may provide input as to whether the support or oppose the measure. This may be reflected at a specific stage, such as the first stage as shown in chart 350-a, which may reflect that the user may support the measure in this example. The user's preference or response may be transmitted to one or more members of the political body, such as Member 1 or Member 2, though other members of the political body may receive information regarding the user's views on the measure. In chart 350-a, the stages may be further divided based on different aspects, such as several different stages with respect to a first chamber, such as a house of representatives, a second chamber, such as a senate, additional votes, and/or final action votes. Other divisions of the stages may be utilized in other embodiments; for example, political bodies that may only include one body may have different divisions, such as no divisions or divisions between initial and final votes.

As the measure passes through stages, it may be determined whether the measure under goes any change. If the bill under goes no change or only minor change, the user's preference, vote, or response on the measure may automatically be updated to reflect the user's preference. This may be reflected in chart 350-b of FIG. 3F, where the user's response of support for a measure may pass through three stages. The chart also reflects the votes of Member 1 as voting for the measure at stage 2 and stage 3.

If the measure changes at one or more stages, the user may be notified, such as through sending a query to the user's device. The user may then provide an updated preference or response regarding the measure. FIG. 3F shows a chart 350-c that reflect the changes as the stages progress. For example, in this case, the measure may have changed at stage 5 and the user may change his or her view on the measure, in this case now opposing the measure, as reflected with the N. In this case, the votes of Member 2 are reflected at stages 5 and 6, showing that they voted for the measure. The one or more members of the political body may be notified of the user's updated preference.

The system may track the preferences of the users along with the specific votes of the one or more members of the political body as it passes through the political body. This may be reflected in charts 350-d and chart 350-e of FIG. 3F. Examples for FIG. 3E and FIG. 3F generally provide a horizontal presentation of the charts 350. FIG. 3G provides a chart 350-f with a vertical orientation, which may be utilized in different embodiments, such as when a user device includes a tablet or smart phone. The system may detect the type of device utilized by the user and orient the chart 350 based in the user device, for example.

The system may provide aggregated results that may compare the votes of the one or more members of the political body to the one or more votes of the user. This may be represented in a user interface, such as a GUI, that tracks these votes along one or more stages. In some cases, the aggregated results may be presented as one or more charts, such as a pie chart or bar chart. An example of such a presentation may chart 360-a be found in FIG. 3H and chart 360-b of FIG. 3I, where two pie charts are presented showing the percentage of agreement for a bill with respect to the user and a Member 1 and a Member 2.

Turning now to FIG. 3J, three staging charts 350-g, 350-h, and 350-i are presented in accordance with various embodiments. These charts 350-g, 350-h, and 350-i may reflect a situation where there may only be two stages and there may be several members of the political body. This may be representative some voting processes for some political bodies, such as a city council. For example, this may reflect where there are two readings of a bill or measure along with votes at each reading. This is presented in a vertical orientation, though a horizontal orientation may be utilized. FIG. 3K shows an example of four staging charts 350-j, 350-k, where there may be four stages and multiple members of the political body; in this example, there may be three members, Member M, Member N, and Member O.

Turning now to FIG. 3L, an input user interface 370 is provided that may be generated for a user device of a user to determine one or more measures (bills in this particular case) of interest to the user being considered by a political body. The interface 370 may be presented as a webpage or other digital interface formats, for example, which may be tailored to the user device being utilized by the user. The user may search for different bills of interest and may select different bills of interest. Merely by way of example, four different bills related to disabilities, retirement, highways, and education are show. Information on the interface 370 may include, but is not limited to, information regarding whether the bill has been passed or killed. The interface 370 may also present information regarding what stage the bill currently is at, along with information regarding how long a user may have to vote on a specific bill with respect to the stage. In this example, the highway bill is highlighted, including information about when the bill may have been introduced into the political body. Different identifies for the bill may also be utilized along with information regarding the bill that may be provided by an entity associated with the political body and/or independent information. This example also shows that the interface 370 reflects that the highway bill has been added to the users list. Information gathered from the interface 370 from the user may transmitted as digital signals from the user device regarding the information related to the one or more bills being considered by the political body of interest to the user. The interface 370 may also be utilized to register the user in some cases.

In this example shown on FIG. 3L, the user may be considering a highway bill that may involve increasing state funding for highways, for a user. A user could be asked if they support or oppose the bill. This may be reflected in user input interface 372 of FIG. 3M, where the user is asked, for example, “Do you support this bill in its current form?” A digital communication from the user device could be transmitted via the interface 372 reflecting the user's support or opposition to the bill, which would be recorded in a database. The interface 372 may also be configured to reflect the user's position regarding the bill with respect to one or more stages. In this case, it is reflected that the user supports the bill at stage 1. Other information may be gathered or provided through interface 372 including, but not limited to, search functions, selected bills, voted bills, user voting profile information, all bills at the political body, and/or login or logout functions. The system may also be configured for determining multiple stages with respect to the bill. The interface 372 may generate a digital stages graphic for the user device to reflect the multiple stages along with at least the responses of the user or the votes of the members of the political body.

The highway bill could continue to pass through the legislative body, such as a state house and its committee structure. As individual members of the house may vote at different stages, the system would record the legislators' votes and update its database. Different systems may also provide an update to the user so that they could track the legislators' votes with respect to the user's votes. If there was no change to the bill or only minor changes, the system may not notify the user; the user's preference on the bill may be carried forward without input from the user. However, in some embodiments, the user may be notified at each stage of the process. For example, the user may notify the system that he or she wants to be notified at each stage of the process.

FIG. 3N shows a user input interface 372-i that may reflect votes of one or more house or senate members along with the votes of the user as the bill passes through numerous stages. In this example, the bill may pass to a senate committee at stage 4, where changes are made to the bill that may not be minor, such as stripping funding from the bill. In this case, the user may be electronically notified of the changes and the user may provide an updated decision as to whether they support or oppose the bill. The user for example may switch their vote from yes to no or vice versa. This may be done at the next stage of voting for example; in this example, the user's change in vote is reflected through the interface 372-i at stage 5. This information may be digitally transmitted to the one or more members of the political body, such as one or more state senators. The information transmitted may include a request from the user to the member of the political body to support or oppose the measure.

Different systems may record in its database when and how one or more members of the political body vote on the one or more bills or measures. The system may continue to notify users when a measure may change. The system may also notify the user on the specific votes of one more members of the political body. In some cases, the system may notify a user when a vote of member of the political body may change.

User input interface 372-i may also show a digital aggregate results graphic reflecting the aggregate results of the user compared to the one or more members of the political body. In this case, two pie charts are generated reflecting the percentage of agreement between the user a first representative and a first senator based on the votes from the multiple stages.

Some embodiments may be configured to provide a digital output that may reflect the overall all results regarding one or more bills or measures, comparing the overall results of the user compared to one or more members of the political body. For example, FIG. 3O shows a digital output 374 as a webpage that may reflect a score card, showing how the user's votes compared to one or more members of the political body, in this case a representative and a senator, during a legislative session for example. These charts reflect the percentage of agreement between the user and the members of the political body with respect to the multiple stages. While digital output 374 shows a comparison between the user and members of the political body with respect to individual bills or measures, some embodiments may provide aggregate results with respect to multiple bills or measures. For example, FIG. 3P shows a digital output 376 that may reflect a percentage of voting agreement for multiple bills, comparing the user's votes to one or more members of the political body with respect to multiple bills.

FIGS. 3L-3P show different configuration in accordance with various embodiments of digital input and/or output interfaces. which may provide the information to gather and/or to track the user's votes along with one or more votes of one or more members of the political body, such as the one or more members of the political body that may represent the users, though some systems may include the votes of other members of the political body that may not directly represent the user. Variations may be utilized that include more or less features. Some embodiments may utilize interfaces such may be graphical user interfaces (GUI). The different systems as shown in FIG. 1 and/or FIGS. 2A-2F may provide the means for implementing the different aspects as shown in FIGS. 3A-3P.

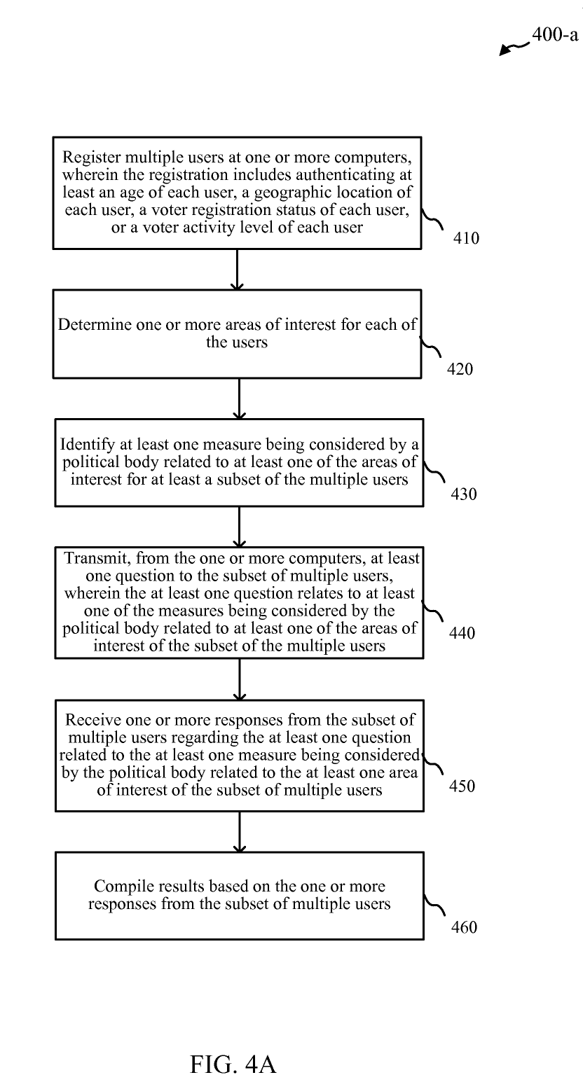

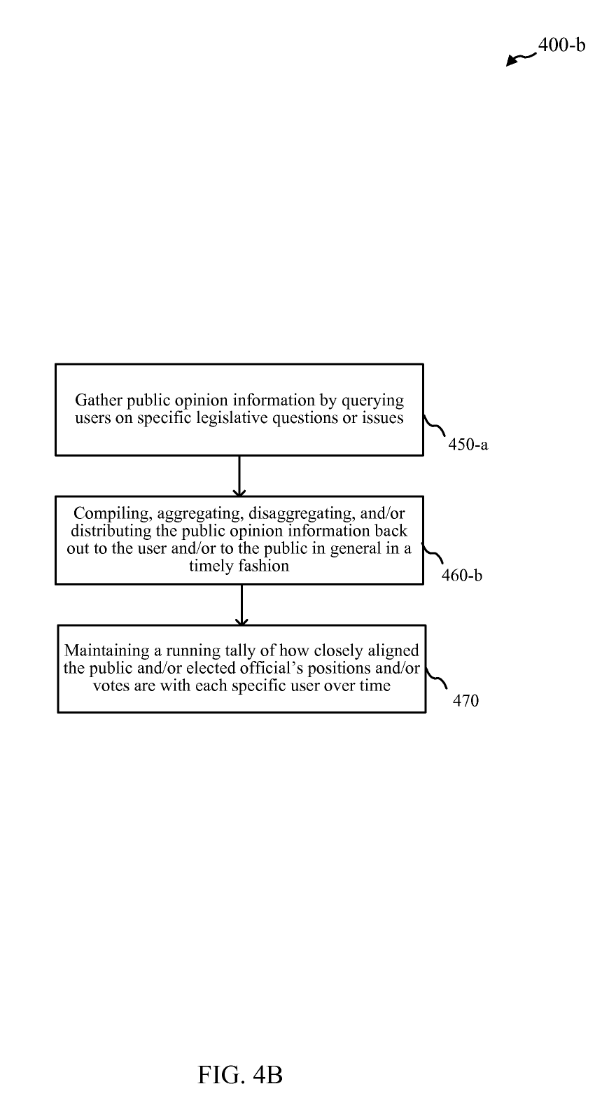

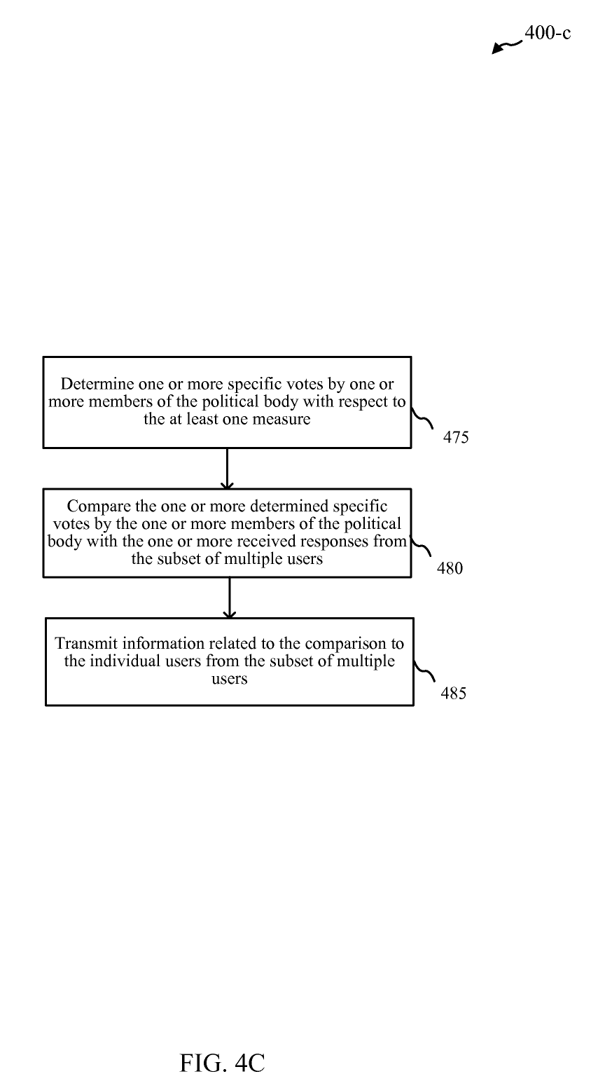

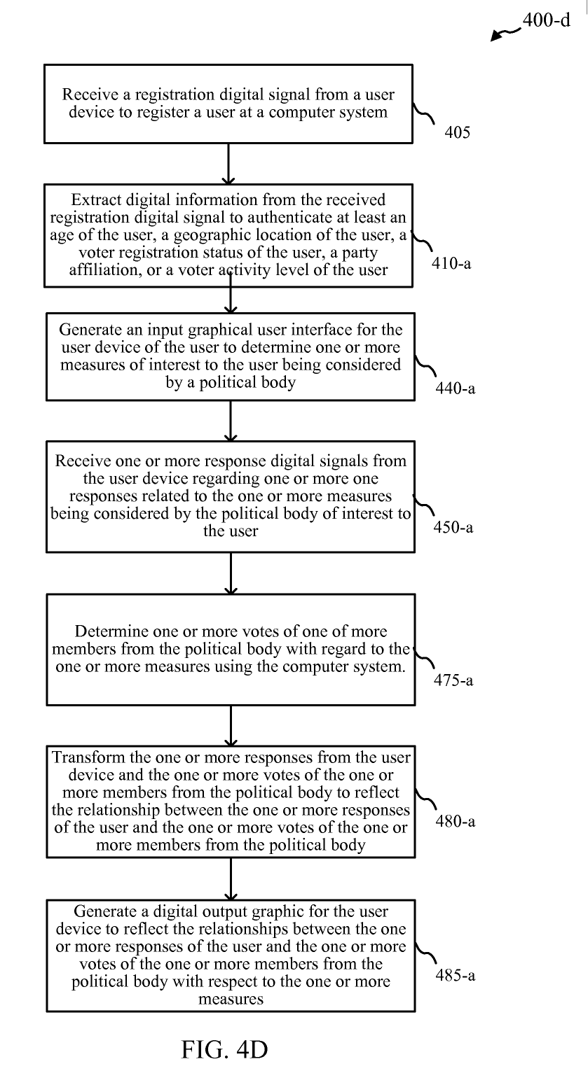

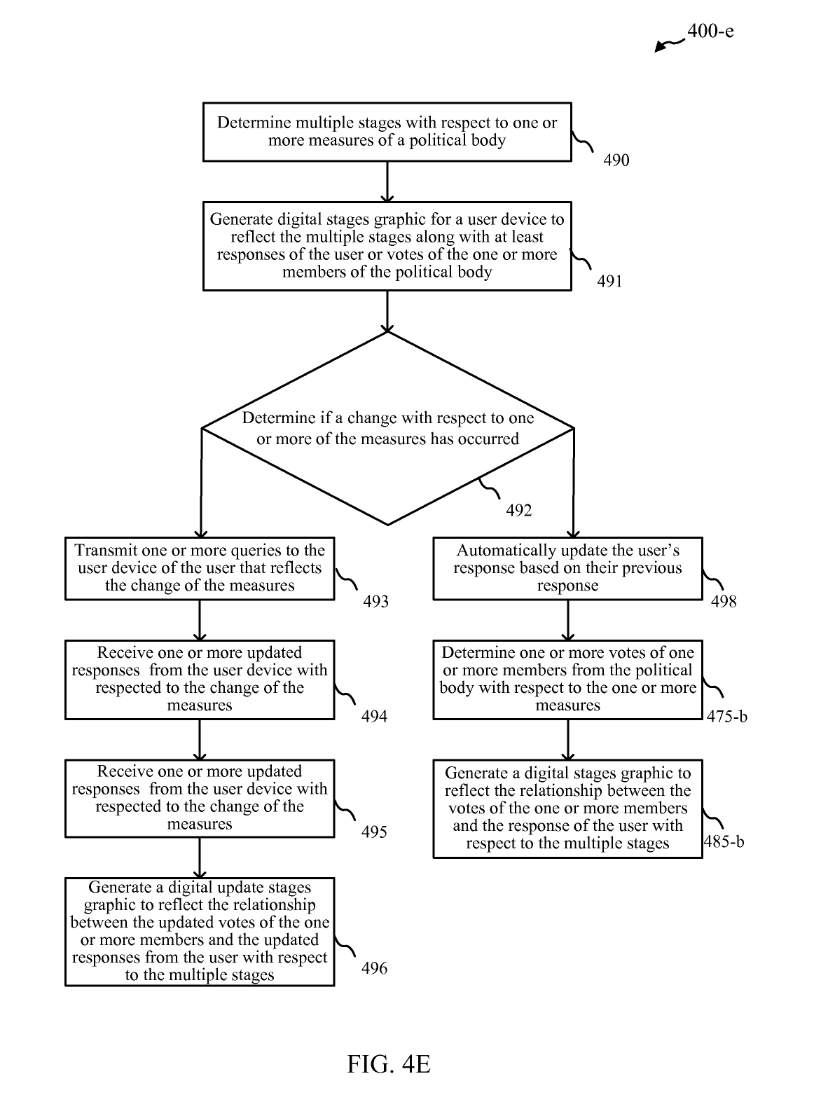

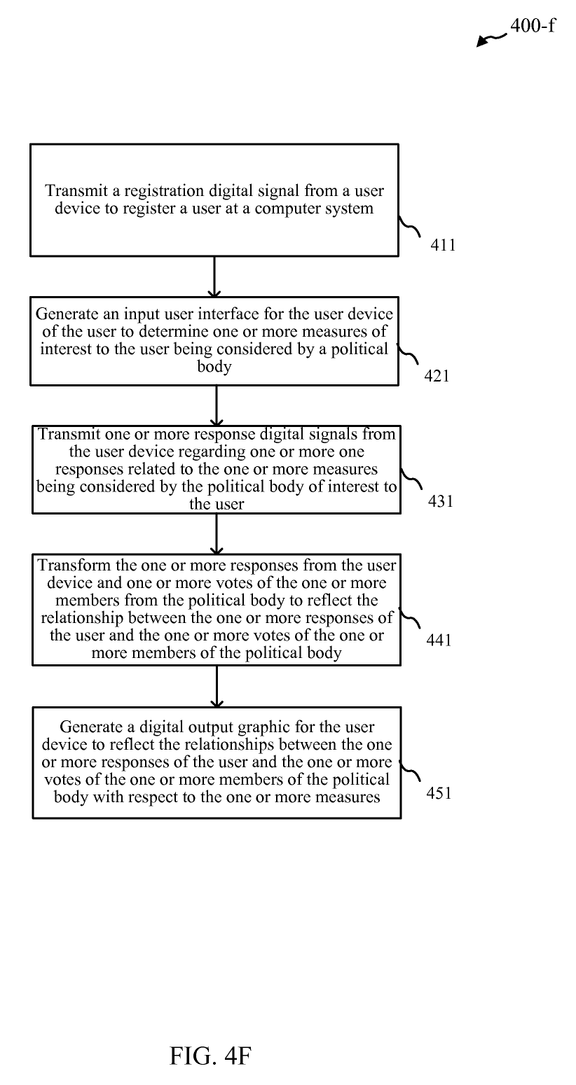

FIG. 4A provides an overview of a method 400-a of gathering and/or providing public opinion information in accordance with various embodiments. Method 400-a may be implemented utilizing aspects of computer system 110 of FIG. 1, system 200-a of FIG. 2A, system 200-b of FIG. 2B, system 200-c of FIG. 2C, and/or system 200-f of FIG. 2F. In FIG. 4A, the specific selection of steps shown and the order in which they are shown is intended merely to be illustrative. It is possible for certain steps to be performed in alternative orders, for certain steps to be omitted, and for certain additional steps to be added according to different embodiments. Some but not all of these variants are noted in the description that follows.

At block 410, multiple users may be registered, at one or more computers. The registration may include authenticating at least an age of each user, a geographic location of each user, a voter registration status of each user, a party affiliation of each user, or a voter activity level of each user.

At block 420, one or more areas of interest for each of the users may be determined. At block 430, at least one measure being considered by a political body related to at least one of the areas of interest for at least a subset of the multiple users may be identified.

At block 440, at least one question to the subset of multiple users may be transmitted from the one or more computers. The at least one question may relate to at least one of the measures being considered by the political body related to at least one of the areas of interest of the subset of the multiple users.

At block 450, one or more responses may be received from the subset of multiple users regarding the at least one question related to the at least one measure being considered by the political body related to the at least one area of interest of the subset of multiple users. At block 460, results may be compiled based on the one or more responses from the subset of multiple users.

Some embodiments of method 400-a may include transmitting the compiled results to at least one member of the political body or one or more users from the subset of multiple users.

Some embodiments of method 400-a may include determining one or more specific votes by one or more members of the political body with respect to the at least one measure. Some embodiments may further include comparing the one or more determined specific votes by the one or more members of the political body with the one or more received responses from the subset of multiple users. Some embodiments of method 400-a may include transmitting information related to the comparison to the individual users from the subset of multiple users.

Some embodiments of method 400-a may include: disaggregating the compiled results based upon at least gender, age, party affiliation, or geographical information of the subset of multiple users; and/or providing publicly the disaggregated results. Some embodiments of method 400-a may include: aggregating the compiled results based upon at least gender, age, party affiliation, or geographical information of the subset of multiple users; and/or providing publicly the aggregated results.

Some embodiments of method 400-a may include determining information regarding individual users from the subset of users at least at a precinct level, a city level, a county level, or a school district level.

Some embodiments of method 400-a may include: generating a map based on the compiled results; and/or presenting the generated map of results. The map may reflect an alignment of the subset of users with one or more members of the political body. In some cases, a map may be produced for individual specific answer questions. In some cases, there may be an ongoing comparison between how each individual user expresses a political opinion (of yes or no on an issue, for example) with how the member of the political body actually votes on those questions. This may involve utilizing a running tally. For example, user X and politician Y may be in congruence 30% of the time (over whatever time period or however many different number of issues . . . 5, 10, 100, etc.) but incongruent 70% of the time or, the results/tallies may be summarized or tallied for specific issues, for example on education or guns. For example, they may be congruence 60% of the time, but off 40% of the time, etc. of politician Y agrees with a user opinion on how to vote on the environmental issues 50% of the time, but not on business issues, where we only agree 20% of the time, etc.

FIG. 4B provides an overview of a method 400-b of gathering and/or providing public opinion information in accordance with various embodiments. Method 400-b may be implemented utilizing aspects of computer system 110 of FIG. 1, system 200-a of FIG. 2A, system 200-b of FIG. 2B, system 200-c of FIG. 2C, and/or system 200-f of FIG. 4F. In FIG. 4B, the specific selection of steps shown and the order in which they are shown is intended merely to be illustrative. It is possible for certain steps to be performed in alternative orders, for certain steps to be omitted, and for certain additional steps to be added according to different embodiments. Some but not all of these variants are noted in the description that follows. Method 400-b may be an example of aspects of method 400-a of 4A.

At block 450-a, public opinion may be gathered by querying users on specific legislative questions or issues. This may allow officeholders at the federal, state, and/or local level to learn the preferences and/or opinions of their constituents before they cast a vote or take a position on the issue in question. At block 460-a, the public opinion information may be received, compiled, aggregated, and/or distributed back out to the user and/or to the public in general in a timely fashion.

At block 470, a running tally may be kept of how closely aligned the public and/or elected official's positions and/or votes are with each specific users over time. In some cases, the information may be disaggregated in myriad ways to align with subscribers by precinct, neighborhood, city/county, house district, senate district, congressional district, by age, sex, etc. In some cases, a tally of how a public official votes on different issues may be maintained for comparison and/or alignment purposes in general. Different subsets may be utilized on some cases including, but not limited to, political party, ethnicity, gender, age, and registration status.

Merely by way of example, after 16 months in office and facing a primary challenge, elected official A might be voting in alignment with subscriber #103 only 45% of the time based on their important issues, but with subscriber #1209 a much healthier 75% of the time. People may be able to use this data when determining whether to support elected official A. Some embodiments may also be able to aggregate this information for public consumption, by announcing on issues of “education” or “the environment,” an elected official A may reflect the subscribers viewpoints 65% of the time for certain precincts within the city of boulder, 50% of the time for the city of boulder in general, but only 40% of the time for countywide resident subscribers, etc.

Some embodiments of method 400-b may utilize user authentication. For example, each voting aged user (e.g., 18+ only) may be uniquely identifiable, based on geographic location for example, and matched to public voter registration information if available. Some embodiments may provide for posting commentary about their position on issues or their support or opposition to how elected officials might be voting on their behalf. In some embodiments, interaction may be considered an option.

Some embodiments of method 400-b may allow for a multi-tiered service model based on cost. For example, a Level 1 may provide a free, basic version of the service, offering the fewest opportunities for opinion gathering (for example, only 10 specific issues) and the least amount of information. Level 2 may provide cost a minimum amount per month, for example $1, and offer between 11-25 questions or issues and more interaction and graphics, a lengthier explanation of issues, etc. Level 3 may provide the 26-50 question range with the most bells and whistles, the prettiest graphics, the most detailed analysis or explanation of issues, more opportunities for interaction, etc. for $10 a month.

Some embodiments of method 400-b may include not selling or otherwise divulging any information about its users, nor make user information available to anyone. In some cases, revenue may not be made from selling advertisements or by allowing other organizations to post on our site, etc. In some cases, a revenue source may include subscriber fees per user, which may depend upon level of service. In some cases, brand loyalty, user comfort and/or satisfaction, and/or increased interactive service between different levels for subscribers will be relevant.

Some embodiments of method 400-b may break down users geographically by precinct to establish state house and senate districts, and/or congressional districts. Some embodiments may be able to distinguish users by more local subdivisions including counties, city council districts/wards, school board member district boundaries, special district boundaries, etc. Some embodiments may utilize a GPS capability of cell phones or other devices as part of the overall authentication process. For example, GPS information may be utilized to authenticate the location of user and/or that the user is associated with a specific geographic location. Other authentication techniques may also be utilized, such as sending security information, such as a Personal Identification Number (PIN), to an authenticated device of a user. Different aspects of encryption may also be utilized for authentication, such as the user of public and/or private keys. Some embodiments may provide authentication by proxy via the state's voter registration lists and/or another process of authentication. Some embodiments may be able to handle non-registered voters. Security features such as encryption and/or different privacy tools and techniques may be utilized in different embodiments in for authenticity purposes and/or to prevent unauthorized individuals or entities from getting users identities and/or votes or opinions on different issues.

Some embodiments of method 400-b may include different database structures that may include different fields regarding different authenticated users including, but not limited to, name, date of birth, address, sex, house district, senate district, congressional district, precinct, subjects, and/or areas of interests. Some embodiments may include databases that may include bill numbers, bill titles, bill subjects, bill summaries, bill details, and/or bill texts. Users and/or subscribers may weigh in and indicate preferences for or against (or don't know/don't care) for their chosen bills.

Some embodiments of method 400-b may involve tracking specific legislation at a state capitol and/or a federal capitol. Some embodiments may track actions being voted upon a town, city, county, and/or school district level. Some embodiments may summarize information regarding specific legislation or matters being considered by a political body and upload the information in a timely fashion in order to be used to gauge the opinion of users. That information may be broken into subjects and/or topics from which the public can choose to weigh in, based on previously indicated user and/or subscriber preferences (e.g., guns, abortion rights, the environment, taxes, etc.) established during the authentication phase.

In some embodiments of method 400-b, based on a level of the user, the poll questions may be pushed out to user and/or subscribers in order to elicit a response and gather feedback within a designated timeframe. These time frames may vary, for example, 1 hour, 3 hours, 6 hours, 12 hours, 24 hours, 36 hours, etc. These times frames may help to ensure public posting in a timely fashion. In some cases, before final vote is taken on the legislation, ordinance, etc. by the elected official, there may be times when this is not possible, but the public posting may occur as soon as technically feasible.

In some embodiments of method 400-b, the polled user and/or subscriber information may be disaggregated down to different levels, such as a precinct level or lower level. In some cases, this disaggregated information may provide a useful model and/or tool for where and how citizens are responding to specific questions of public policy compared to how those issues are actually voted on by their own elected officials. Polled information may not be publicly released to correspond to any individual user and/or subscriber. Polled information may be released in aggregated or disaggregated format, which may not be individually identifiable.

Some embodiments of method 400-b may provide a map feature that may aggregate and/or disaggregate user and/or subscriber preferences, which may show alignment or non-alignment with elected officials voting actions. For example, an interactive map of the whole state may have precinct specific information broken down by issue, which may then be aggregated into state house and senate districts, then congressional districts, etc. User and/or subscribers may see how elected officials align with their responses, the number of other user and/or subscribers located in other precincts, the percentages of alignment, and/or the number of issues tabulated, etc. In some embodiments, the map features may include interactive type maps that may utilize color scales (e.g., blue for cold, yellow for warm, red for hot, shades of grey, etc.) Some users and/or subscribers may expect more interactivity and/or details for graphics and functionality, which may be provided in different embodiments. Some maps can be used by the general public—even non user and/or subscribers—and others may only be available to users.

Some embodiments of method 400-b may provide more interactive opportunities for users to contact their legislators and political officials about their opinions on issues, send correspondence to newspapers, post comments in public domains, start their own petitions or ideas for legislation, and/or interact with other users, etc. from our platform. In some embodiments, users may be able to link to websites of elected officials and other public or government sites that connect them to specific bills or information about issues, candidates, organizations, and/or outside sources, etc. Some embodiments may provide for links to other petition sites (e.g., change.org, moveon.org, Care2petition.org, etc.), political parties, news media, etc.

FIG. 4C provides an overview of a method 400-c of gathering and/or providing public opinion information in accordance with various embodiments. Method 400-c may be implemented utilizing aspects of computer system 110 of FIG. 1, system 200-a of FIG. 2A, system 200-b of FIG. 2B, system 200-c of FIG. 2C, and/or system 200-f of FIG. 2F. In FIG. 4C, the specific selection of steps shown and the order in which they are shown is intended merely to be illustrative. It is possible for certain steps to be performed in alternative orders, for certain steps to be omitted, and for certain additional steps to be added according to different embodiments. Some but not all of these variants are noted in the description that follows. Method 400-c may be utilized in conjunction with method 400-a of FIG. 4A and/or method 400-b of FIG. 4B.

At block 475, one or more specific votes by one or more members of the political body with respect to the at least one measure may be determined. At block 480, the one or more determined specific votes by the one or more members of the political body may be compared with the one or more received responses from the subset of multiple users. This may be utilized to determine alignment between the one or more members of the political body with the subset of multiple users with respect to the at least one measure. At block 485, information related to the comparison may be transmitted to the individual users from the subset of multiple users.

FIG. 4D provides an overview of another method 400-d of gathering and/or providing public opinion information in accordance with various embodiments. Method 400-d may be implemented utilizing aspects of computer system 110 of FIG. 1, system 200-a of FIG. 2A, system 200-b of FIG. 2B, system 200-c of FIG. 2C, and/or system 200-f of FIG. 2F. In FIG. 4D, the specific selection of steps shown and the order in which they are shown is intended merely to be illustrative. It is possible for certain steps to be performed in alternative orders, for certain steps to be omitted, and for certain additional steps to be added according to different embodiments. Some but not all of these variants are noted in the description that follows.

At block 405, a registration digital signal may be received from a user device to register the user at a computer system. At block 410-a, digital information may be extracted from the received registration digital signal to authenticate at least an age of the user, a geographic location of the user, a voter registration status of the user, a party affiliation, or a voter activity level of the user.

At block 440-a, an input graphical user interface for the user device of the user may be generated to determine one or more measures of interest to the user being considered by a political body. At block 450-a, one or more response digital signals may be received from the user device regarding one or more one responses related to the one or more measures being considered by the political body of interest to the user.

At block 475-a, one or more votes of one of more members from the political body may be determined with regard to the one or more measure using the computer system. At block 480-a, the one or more responses from the user device and the one or more votes of the one or more members from the political body may be transformed to reflect the relationship between the one or more responses of the user and the one or more votes of the one or more members from the political body. At block 490-a, a digital output graphic may be generated for the user device to reflect the relationships between the one or more responses of the user and the one or more votes of the one or more members from the political body with respect to the one or more measures. Some embodiments of method 400-d may include transmitting the one or more responses from the user device to one or more devices of the one or more members of the political body.

Some embodiments of method 400-d may include determining multiple stages with respect to the one or more measures. In some embodiments, digital stages graphic may be generated for the user device to reflect the multiple stages along with at least the responses of the user or the votes of the one or more members from the political body.

In some cases, a change may be determined with respect to at least one of the one or more measures. One or more queries may be transmitted to the user device of the user that reflects the change of the measure. One or more updated responses may be received from the user device with respected to the change of the measure. An update response graphic may be generated for the user device to reflect the updated response.

In some embodiments, one or more updated votes of one of more members from the political body may be determined with regard the change with respect to the one or more measures. A digital update stages graphic may be generated to reflect the relationship between the updated votes of the one or more members from the political body and the updated responses from the user with respect to the multiple stages.

Some embodiments of method 400-d may include generating a digital aggregate results graphic reflecting the aggregate results of the user compared to the one or more members from the political body.

Some embodiments of method 400-d may include protecting the user votes from being identified by an administrator of the computer system. This may be done in numerous ways, such as encrypting the user's voting information, segregating the user's voting information from access by a administrator or other individual different from the user, and/or removing user information with respect to the user's votes when viewed by an administrator or other individual different from the user. Other techniques may be utilized to protect to the user's votes from by identified by the administrator or other individuals different from the user.

Some embodiments of method 400-d may include aggregating compiled results based upon at least gender, age, party affiliation, or geographical information of multiples users. The aggregated results may be transmitted in digital format for public display. Some embodiments may include generating a digital graphic map based on the compiled results for the user device. The digital graphic map may reflect an alignment of the subset of users with one or more members of the political body.

FIG. 4E provides an overview of another method 400-e of gathering and/or providing public opinion information in accordance with various embodiments. Method 400-e may be implemented utilizing aspects of computer system 110 of FIG. 1, system 200-a of FIG. 2A, system 200-b of FIG. 2B, system 200-c of FIG. 2C, and/or system 200-f of FIG. 2F. In FIG. 4E, the specific selection of steps shown and the order in which they are shown is intended merely to be illustrative. It is possible for certain steps to be performed in alternative orders, for certain steps to be omitted, and for certain additional steps to be added according to different embodiments. Some but not all of these variants are noted in the description that follows.

At block 490, multiple stages with respect to the one or more measures may be determined. At block 491, a digital stages graphic may be generated for the user device to reflect the multiple stages along with at least the responses of the user or the votes of the one or more members of the political body.

At block 492 it may be determined whether a change with respect to at least one of the one or more measures has occurred. If it is determined at block 492 that a change has occurred, one or more queries may be transmitted to the user device of the user that reflects the change of the measure at block 493. At block 494, one or more updated responses may be received from the user device with respected to the change of the measure. In some cases, an update response graphic may be generated for the user device to reflect the updated response.

At block 495, one or more updated votes of one of more members from the political body may be determined with regard the change with respect to the one or more measures. At block 496, a digital update stages graphic may be generated to reflect the relationship between the updated votes of the one or more members and the updated responses from the user with respect to the multiple stages.

If at block 492 it may be determined that no change, or no change of significance has occurred, a users response may be automatically updated with respect to their previous response at block 498. In some cases, one or more votes of one of more members from the political body may be determined with respect to the one or more measures at block 475-b. At block 485-b, a digital stages graphic may be generated to reflect the relationship between the votes of the one or more members and the responses from the user with respect to the multiple stages.

FIG. 4F provides an overview of another method 400-f of gathering and/or providing public opinion information in accordance with various embodiments. Method 400-f may be implemented utilizing aspects of user device 115 of FIG. 1, system 200-d of FIG. 2D, and/or system 200-f of FIG. 2E. In FIG. 4F, the specific selection of steps shown and the order in which they are shown is intended merely to be illustrative. It is possible for certain steps to be performed in alternative orders, for certain steps to be omitted, and for certain additional steps to be added according to different embodiments. Some but not all of these variants are noted in the description that follows.

At block 411, a registration digital signal may be transmitted from a user device to register a user at a computer system. At block 421, an input user interface may be generated for the user device of the user to determine one or more measures of interest to the user being considered by a political body. At block 431, one or more response digital signals may be transmitted from the user device regarding one or more response related to the one or more measures being considered by the political body of interest to the user. At block 431, the one or more responses from the user device and one or more votes of the one or more members from the political body may be transformed to reflect the relationship between the one or more responses of the user and the one or more votes of the one or more members of the political body. At block 451, a digital output graphic may be generated for the user device to reflect the relationships between the one or more responses of the user and the one or more votes of the one or more members of the political body with respect to the one or more measures. Some embodiments of method 400-f may include transmitting the one or more responses from the user device to one or more devices of the one or more members of the political body.

Some embodiments of method 400-f may include determining multiple stages with respect to the one or more measures. A digital stages graphic may be generated for the user device to reflect the plurality of stages along with at least the responses of the user or the votes of the members.

Some embodiments of method 400-f may include receiving one or more queries to the user device of the user that reflects the change of the measure. One or more updated responses may be transmitted from the user device with respected to the change of the measure. An update response graphic may be generated for the user device to reflect the updated response. Some embodiments may include generating a digital update stages graphic to reflect the relationship between updated votes of the one or more members and the updated responses from the user with respect to the plurality of stages.

Some embodiments of method 400-f may include generating a digital aggregate results graphic reflecting the aggregate results of the user compared to the one or more members of the user.

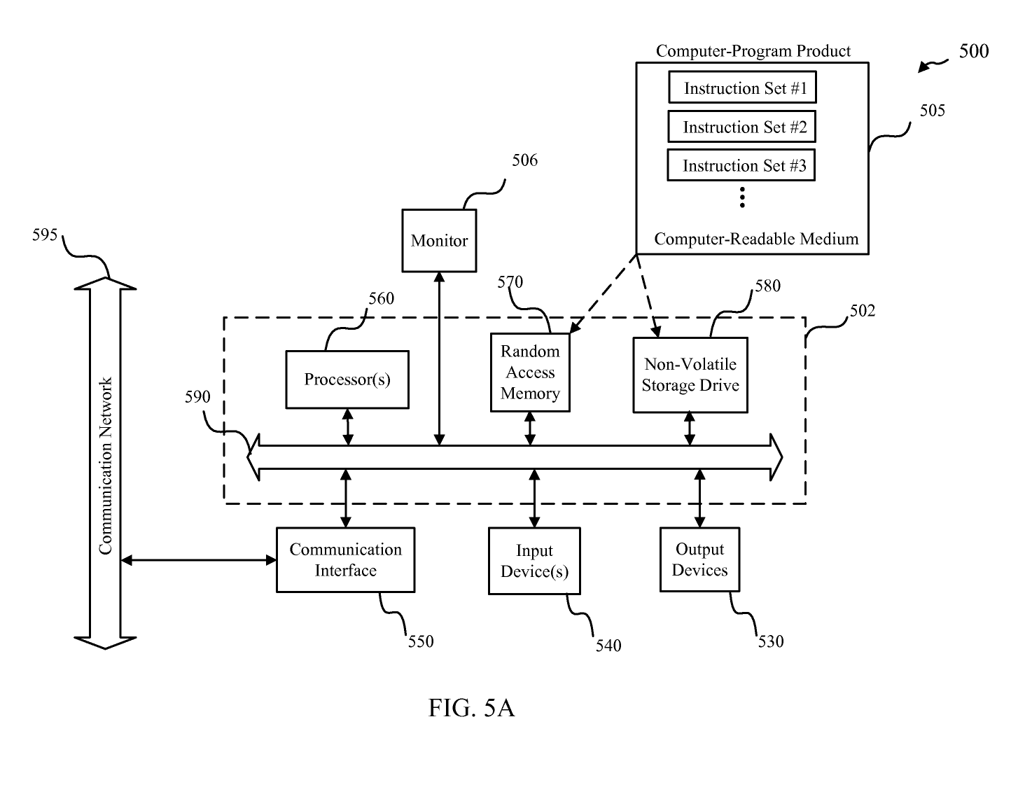

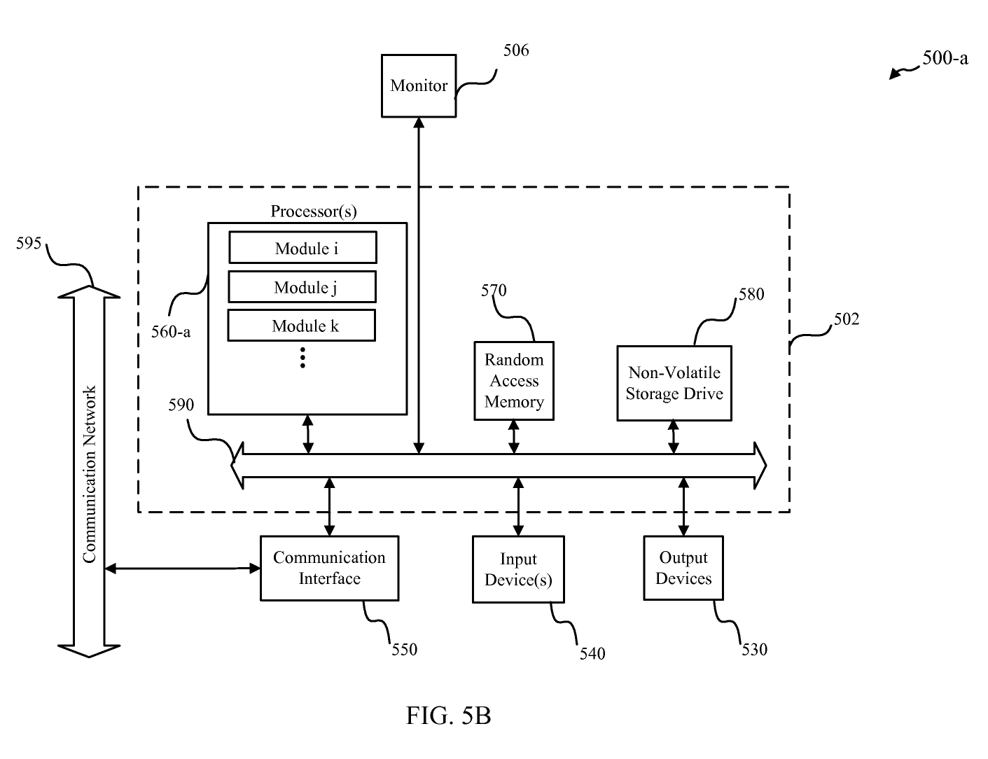

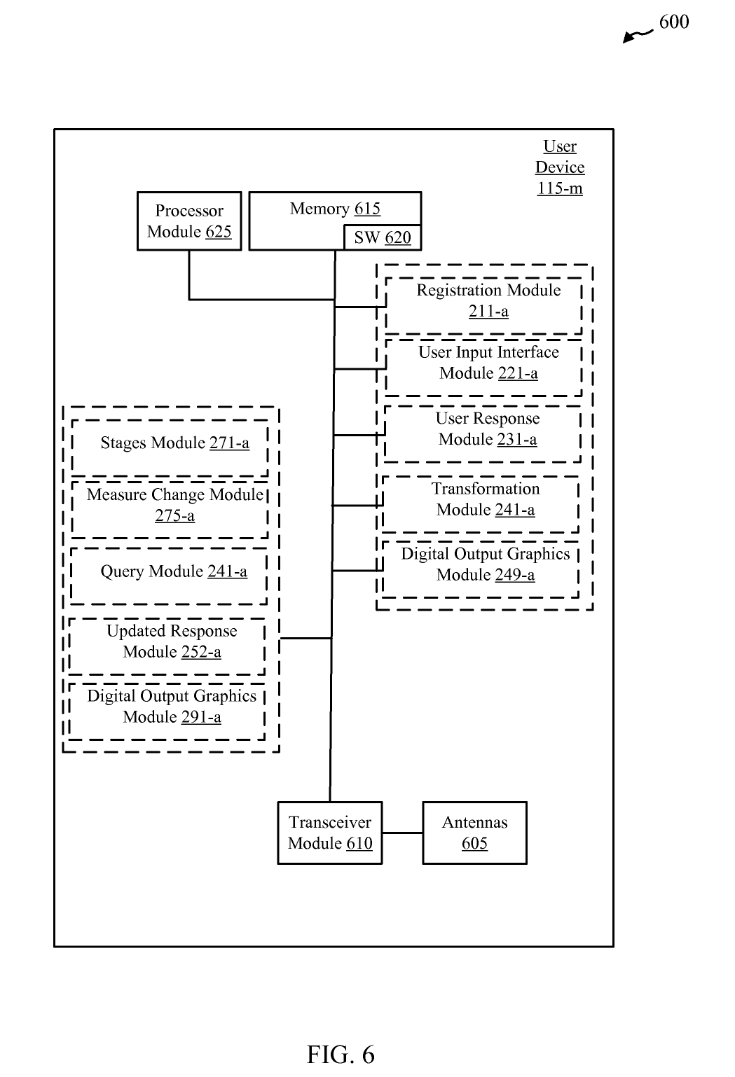

With reference to FIG. 5A, an embodiment of a special-purpose computer system 500 is shown. The above methods may be implemented by computer-program products that direct a computer system to perform the actions of the above-described methods and components. Systems 110, 200-a, 200-b, 200-c, 200-d, 200-e, and/or 200-f may utilize one or more aspects of computer system 500; in some embodiments, user device 115 may utilize one or more aspects of computer system 500. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system, it is transformed into the special-purpose computer system 500 for gathering and/or providing public opinion information. Some embodiments may include a tangible, non-transitory computer readable medium that may include sets of instructions that may direct one or more processors of a computer system to perform corresponding actions, such as the actions discuss with respect to the methods of FIG. 4A, FIG. 4B, FIG. 4C, FIG. 4D, FIG. 4E, and/or FIG. 4F, for example.

Special-purpose computer system 500 may include a computer 502, a monitor 506 coupled to computer 502, one or more additional user output devices 530 (optional) coupled with computer 502, one or more user input devices 540 (e.g., keyboard, mouse, track ball, touch screen) coupled with computer 502, an optional communications interface 550 coupled with computer 502, and a computer-program product 505 stored in a tangible computer-readable memory in computer 502. Computer-program product 505 may direct system 500 to perform the above-described methods. Computer 502 may include one or more processors 560 that may communicate with a number of peripheral devices via a bus subsystem 590. These peripheral devices may include user output device(s) 530, user input device(s) 540, communications interface 550, and/or a storage subsystem, such as random access memory (RAM) 570 and non-volatile storage drive 580 (e.g., disk drive, optical drive, solid state drive), which are forms of tangible computer-readable memory.

Computer-program product 505 may be stored in non-volatile storage drive 580 or another computer-readable medium accessible to computer 502 and loaded into memory 570. Each processor 560 may include a microprocessor, such as a microprocessor from Intel® or Advanced Micro Devices, Inc.®, or the like. To support computer-program product 505, the computer 502 may run an operating system that handles the communications of product 505 with the above-noted components, as well as the communications between the above-noted components in support of the computer-program product 505. Exemplary operating systems may include Windows® or the like from Microsoft Corporation, Solaris® from Sun Microsystems, LINUX, UNIX, and the like.

User input devices 540 may include all possible types of devices and mechanisms for inputting information to computer system 502. These may include a keyboard, a keypad, a mouse, a scanner, a digital drawing pad, a touch screen incorporated into the display, audio input devices such as voice recognition systems, microphones, and/or other types of input devices. In various embodiments, user input devices 540 are typically embodied as a computer mouse, a trackball, a track pad, a joystick, wireless remote, a drawing tablet, or a voice command system. User input devices 540 typically may allow a user to select objects, icons, text and the like that appear on the monitor 506 via a command such as a click of a button or the like. User output devices 530 include all possible types of devices and mechanisms for outputting information from computer 502. These may include a display (e.g., monitor 506), printers, non-visual displays such as audio output devices, etc.

Communications interface 550 may provide an interface to other communication networks and devices and may serve as an interface for receiving data from and transmitting data to other systems, WANs and/or the Internet 518. Embodiments of communications interface 550 typically may include an Ethernet card, a modem (telephone, satellite, cable, ISDN), a (asynchronous) digital subscriber line (DSL) unit, a FireWire® Interface, a USB® interface, a wireless network adapter, and the like. For example, communications interface 550 may be coupled to a computer network, to a FireWire® bus, or the like. In other embodiments, communications interface 550 may be physically integrated on the motherboard of computer 502, and/or may be a software program, or the like.

RAM 570 and non-volatile storage drive 580 may include examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 570 and non-volatile storage drive 580 may be configured to store the basic programming and data constructs that provide the functionality of various embodiments, as described above.

Software instruction sets that provide the functionality of the present invention may be stored in RAM 570 and non-volatile storage drive 580. These instruction sets or code may be executed by the processor(s) 560. RAM 570 and non-volatile storage drive 580 may also provide a repository for storing data and data structures used in accordance with the present invention. RAM 570 and non-volatile storage drive 580 may include a number of memories including a main random access memory (RAM) for storage of instructions and data during program execution and a read-only memory (ROM) in which fixed instructions are stored. RAM 570 and non-volatile storage drive 580 may include a file storage subsystem providing persistent (non-volatile) storage for program and/or data files. RAM 570 and non-volatile storage drive 580 may also include removable storage systems, such as removable flash memory.

Bus subsystem 590 may provide a mechanism for letting the various components and subsystems of computer 502 to communicate with each other as intended. Although bus subsystem 590 is shown schematically as a single bus, alternative embodiments of the bus subsystem may utilize multiple busses or communication paths within the computer 502.

With reference to FIG. 5B, an embodiment of another special-purpose computer system 500-a is shown. The above methods may be implemented by computer-program products that direct a computer system to perform the actions of the above-described methods and components. Computer system 500-a may be an example of aspects of computer system 500. Computer systems 110, 200-a, 200-b, 200-c, 200-d, 200-e, and/or 200-f may utilize one or more aspects of computer system 500-a; in some cases, user device 115 may utilize one or more aspects of computer system 500-a. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system, it is transformed into the special-purpose computer system 500-a for gathering and/or providing public opinion information.

Special-purpose computer system 500-a may include a computer 502, a monitor 506 coupled to computer 502, one or more additional user output devices 530 (optional) coupled with computer 502, one or more user input devices 540 (e.g., keyboard, mouse, track ball, touch screen) coupled with computer 502, an optional communications interface 550 coupled with computer 502. Computer 502 may include one or more processors 560-a that may communicate with a number of peripheral devices via a bus subsystem 590. These peripheral devices may include user output device(s) 530, user input device(s) 540, communications interface 550, and/or a storage subsystem, such as random access memory (RAM) 570 and non-volatile storage drive 580 (e.g., disk drive, optical drive, solid state drive), which are forms of tangible computer-readable memory.

Computer-program product may be stored in non-volatile storage drive 580 or another computer-readable medium accessible to computer 502 and loaded into memory 570. Each processor 560-a may include a microprocessor, such as a microprocessor from Intel® or Advanced Micro Devices, Inc.®, or the like. Processor(s) may include one or more specific modules that may be configured to perform different aspects of different embodiments. The computer 502 may run an operating system that handles the communications of computer-program product with the above-noted components, as well as the communications between the above-noted components in support of the computer-program product. Exemplary operating systems may include Windows® or the like from Microsoft Corporation, Solaris® from Sun Microsystems, LINUX, UNIX, and the like. Processors 560-a may include one or more modules, such as module i, module j, module k, . . . . These processor modules may be configured to as the modules as described with respect to system 200-a, 200-b, 200-c, 200-d, 200-e, and/or 200-f.

User input devices 540 may include all possible types of devices and mechanisms for inputting information to computer system 502. These may include a keyboard, a keypad, a mouse, a scanner, a digital drawing pad, a touch screen incorporated into the display, audio input devices such as voice recognition systems, microphones, and/or other types of input devices. In various embodiments, user input devices 540 are typically embodied as a computer mouse, a trackball, a track pad, a joystick, wireless remote, a drawing tablet, or a voice command system. User input devices 540 typically may allow a user to select objects, icons, text and the like that appear on the monitor 506 via a command such as a click of a button or the like. User output devices 530 include all possible types of devices and mechanisms for outputting information from computer 502. These may include a display (e.g., monitor 506), printers, non-visual displays such as audio output devices, etc.

Communications interface 550 may provide an interface to other communication networks and devices and may serve as an interface for receiving data from and transmitting data to other systems, WANs and/or the Internet 518. Embodiments of communications interface 550 typically may include an Ethernet card, a modem (telephone, satellite, cable, ISDN), a (asynchronous) digital subscriber line (DSL) unit, a FireWire® Interface, a USB® interface, a wireless network adapter, and the like. For example, communications interface 550 may be coupled to a computer network, to a FireWire® bus, or the like. In other embodiments, communications interface 550 may be physically integrated on the motherboard of computer 502, and/or may be a software program, or the like.

RAM 570 and non-volatile storage drive 580 may include examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 570 and non-volatile storage drive 580 may be configured to store the basic programming and data constructs that provide the functionality of various embodiments, as described above.

Software instruction sets that provide the functionality of the different embodiments may be stored in RAM 570 and non-volatile storage drive 580. These instruction sets or code may be executed by the processor(s) 560-a. RAM 570 and non-volatile storage drive 580 may also provide a repository for storing data and data structures used in accordance with the present invention. RAM 570 and non-volatile storage drive 580 may include a number of memories including a main random access memory (RAM) for storage of instructions and data during program execution and a read-only memory (ROM) in which fixed instructions are stored. RAM 570 and non-volatile storage drive 580 may include a file storage subsystem providing persistent (non-volatile) storage for program and/or data files. RAM 570 and non-volatile storage drive 580 may also include removable storage systems, such as removable flash memory.

Bus subsystem 590 may provide a mechanism for letting the various components and subsystems of computer 502 to communicate with each other as intended. Although bus subsystem 590 is shown schematically as a single bus, alternative embodiments of the bus subsystem may utilize multiple busses or communication paths within the computer 502.

FIG. 6 is a block diagram 600 of a user device 115-m in accordance with various embodiments. User device 115-m may be an example of user equipment 115 of FIG. 1 and/or aspects of system 200-d of FIG. 2D and/or system 200-e of FIG. 2E. The user device 115-m may have any of various configurations, such as personal computers (e.g., laptop computers, netbook computers, tablet computers, etc.), cellular telephones, PDAs, digital video recorders (DVRs), internet appliances, gaming consoles, e-readers, etc. The user device 115-m may have an internal power supply (not shown), such as a small battery, to facilitate mobile operation.

The user device 115-m may include antennas 605, a transceiver module 610, memory 615, and/or a processor module 625, which each may be in communication, directly or indirectly, with each other (e.g., via one or more buses). The transceiver module 610 is configured to communicate bi-directionally, via the antennas 605 and/or one or more wired or wireless links, with one or more networks, as described above. The transceiver module 610 may include a modem configured to modulate the packets and provide the modulated packets to the antennas 605 for transmission, and to demodulate packets received from the antennas 605. While the user device 115-m may include a single antenna, the user device 115-m may include multiple antennas 605 for multiple links.

The memory 615 may include random access memory (RAM) and read-only memory (ROM). The memory 615 may store computer-readable, computer-executable software code 620 containing instructions that are configured to, when executed, cause the processor module 625 to perform various functions described herein (e.g., call processing, database management, message routing, etc.). Alternatively, the software 620 may not be directly executable by the processor module 625 but be configured to cause the computer (e.g., when compiled and executed) to perform functions described herein.

The processor module 625 may include an intelligent hardware device, e.g., a central processing unit (CPU), a microcontroller, an application specific integrated circuit (ASIC), etc. The processor module 625 may include a speech encoder (not shown) configured to receive audio via a microphone, convert the audio into packets (e.g., 30 ms in length) representative of the received audio, provide the audio packets to the transceiver module 610, and provide indications of whether a user is speaking. Alternatively, an encoder may only provide packets to the transceiver module 610, with the provision or withholding/suppression of the packet itself providing the indication of whether a user is speaking.

The components of the user device 115-m may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the user device 115-m.

The components for user device 115-m may be configured to implement aspects discussed above with respect to system 200-d of FIG. 2D and/or system 200-e of FIG. 2E may not be repeated here for the sake of brevity. Registration module 211-a may be an example of registration module 211 of FIG. 2D. User input interface module 221-a may be an example of user input interface module 221 of FIG. 2D. User response module 231-a may be an example of user response module 231 of FIG. 2D. Transformation module 241-a may be an example of transformation module 241 of FIG. 2D. Digital output graphics module 249-a may be an example of digital output graphics module 249 of FIG. 2D. Stages module 271-a may be an example of stages module 271 of FIG. 2E. Measure change module 275-a may be an example of measure change module 275 of FIG. 2E. Query module 241-a may be an example of query module 241 of FIG. 2E. Updated response module 252-a may be an example of updated response module 252 of FIG. 2E. Digital output graphics module 291-a may be an example of digital output graphic module 291 of FIG. 2E.

The previous description provides exemplary embodiments only and is not intended to limit the scope, applicability, or configuration of the disclosure. Rather, the previous description of the exemplary embodiments will provide those skilled in the art with an enabling description for implementing one or more exemplary embodiments. It is understood that various changes may be made in the function and arrangement of elements without departing from the spirit and scope of the invention. Several embodiments were described herein, and while various features are ascribed to different embodiments, it should be appreciated that the features described with respect to one embodiment may be incorporated within other embodiments as well. By the same token, however, no single feature or features of any described embodiment should be considered essential to every embodiment of the invention, as other embodiments of the invention may omit such features.

Specific details are given in the previous description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process may be terminated when its operations are completed, but could have also included additional steps or operations not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

While detailed descriptions of one or more embodiments have been given above, various alternatives, modifications, and equivalents will be apparent to those skilled in the art without varying from the spirit of the different embodiments. Moreover, except where clearly inappropriate or otherwise expressly noted, it should be assumed that the features, devices, and/or components of different embodiments may be substituted and/or combined. Thus, the above description should not be taken as limiting the scope of the different embodiments, which is defined by the appended claims.

What is claimed is:

1. A method of gathering public opinion information comprising:
receiving a registration digital signal from a user device to register a user at a computer system;
extracting digital information from the received registration digital signal to authenticate at least an age of the user, a geographic location of the user, a voter registration status of the user, a party affiliation, or a voter activity level of the user;
generating an input user interface for the user device of the user to determine one or more measures of interest to the user being considered by a political body;
receiving one or more response digital signals from the user device regarding one or more one responses related to the one or more measures of interest to the user being considered by the political body;
determining one or more votes of one of more members from the political body with regard to the one or more measures using the computer system;
transforming the one or more responses from the user device and the one or more votes of the one or more members from the political body to reflect the relationship between the one or more responses of the user and the one or more votes of the one or more members from the political body; and
generating a digital output graphic for the user device to reflect the relationship between the one or more responses of the user and the one or more votes of the one or more members from the political body with respect to the one or more measures.

2. The method of claim 1, further comprising:
transmitting the one or more responses received from the user device to one or more devices of the one or more members from the political body.

3. The method of claim 1, further comprising:
determining a plurality of stages with respect to the one or more measures; and
generating a digital stages graphic for the user device to reflect the plurality of stages along with the one or more responses of the user or the one or more votes of the one or more members from the political body.

4. The method of claim 1, further comprising:
determining a change with respect to at least one of the one or more measures;
transmitting one or more queries to the user device of the user that reflects the change of the one or more measures;
receiving one or more updated responses from the user device with respect to the change of the one or more measures; and
generating an update response graphic for the user device to reflect the updated response.

5. The method of claim 4, further comprising:
determining one or more updated votes of the one of more members from the political body with regard the change with respect to the one or more measures; and
generating a digital update stages graphic to reflect the relationship between the updated votes of the one or more members from the political body and the updated responses from the user with respect to the plurality of stages.

6. The method of claim 5, further comprising:
generating a digital aggregate results graphic reflecting the aggregate results of the user compared to the one or more members from the political body with respect to the one or more measures.

7. The method of claim 1, further comprising:
protecting the user votes from being identified by an administrator of the computer system.

8. The method of claim 1, further comprising:
aggregating results based upon at least gender, age, party affiliation, or geographical information of a plurality of users; and
transmitting the aggregated results in digital format for public display.

9. The method of claim 1, further comprising:
generating a digital graphic map based on the aggregated results for the user device.

10. The method of claim 9, wherein the digital graphic map reflects an alignment of the subset of users with one or more members from the political body.

11. A system for gathering public opinion information comprising:
one or more processors configured to:
receive a registration digital signal from a user device to register a user at a computer system;
extract digital information from the received registration digital signal to authenticate at least an age of the user, a geographic location of the user, a voter registration status of the user, a party affiliation, or a voter activity level of the user;
generate an input user interface for the user device of the user to determine one or more measures of interest to the user being considered by a political body
receive one or more response digital signals from the user device regarding one or more one responses related to the one or more measures being considered by the political body of interest to the user;
determine one or more votes of one of more members from the political body with regard to the one or more measures using the computer system;
transform the one or more responses from the user device and the one or more votes of the one or more members from the political body to reflect the relationship between the one or more responses of the user and the one or more votes of the one or more members from the political body; and
generate a digital output graphic for the user device to reflect the relationships between the one or more responses of the user and the one or more votes of the one or more members the political body with respect to the one or more measures.

12. The system of claim 11, wherein the one or more processors are further configured to transmit the one or more responses received from the user device to one or more devices of the one or more members from the political body.

13. The system of claim 11, wherein the one or more processors are further configured to:
determine a plurality of stages with respect to the one or more measures; and
generate a digital stages graphic for the user device to reflect the plurality of stages along with the one or more responses of the user or the one or more votes of the one or more members from the political body.

14. The system of claim 11, wherein the one or more processors are further configured to:
determine a change with respect to at least one of the one or more measures;
transmit one or more queries to the user device of the user that reflects the change of the one or more measures;
receive one or more updated responses from the user device with respected to the change of the one of more measures; and
generate an update response graphic for the user device to reflect the updated response.

15. The system of claim 14, wherein the one or more processors are further configured to:
determine one or more updated votes of the one of more members from the political body with regard the change with respect to the one or more measures; and
generate a digital update stages graphic to reflect the relationship between the updated votes of the one or more members and the updated responses from the user with respect to the plurality of stages.

16. The system of claim 15, wherein the one or more processors are further configured to generate a digital aggregate results graphic reflecting the aggregate results of the user compared to the one or more members from the political body with respect to the one or more measures.

17. The system of claim 11, wherein the one or more processors are further configured to protect the user votes from being identified by an administrator of the computer system.

18. The system of claim 11, wherein the one or more processors are further configured to:
aggregate results based upon at least gender, age, party affiliation, or geographical information of a plurality of users; and
transmit the aggregated results in digital format for public display.

19. The system of claim 11, wherein the one or more processors are further configured to generate a digital graphic map based on the aggregated results for the user device.

20. A system for gathering public opinion information comprising:
means for receiving a registration digital signal from a user device to register a user at a computer system;
means for extracting digital information from the received registration digital signal to authenticate at least an age of the user, a geographic location of the user, a voter registration status of the user, a party affiliation, or a voter activity level of the user;
means for generating an input user interface for the user device of the user to determine one or more measures of interest to the user being considered by a political body;
means for receiving one or more response digital signals from the user device regarding one or more one responses related to the one or more measures being considered by the political body of interest to the user;
means for determining one or more votes of one of more members from the political body with regard to the one or more measures using the computer system;
means for transforming the one or more responses from the user device and the one or more votes of the one or more members from the political body to reflect the relationship between the one or more responses of the user and the one or more votes of the one or more members from the political body; and
means for generating a digital output graphic for the user device to reflect the relationships between the one or more responses of the user and the one or more votes of the one or more members from the political body with respect to the one or more measures.
